(19) United States
(12) Patent Application Publication
(10) Pub. No.: US 2024/0294030 A1
(43) Pub. Date: Sep. 5, 2024

(54) Mechanical pencil

(71) Applicant: Wenzhou Jianxi Stationery Co., Ltd., Wenzhou (CN)

(72) Inventor: Yingying SONG, Hangzhou (CN)

(21) Appl. No.: 18/648,174

(22) Filed: Apr. 26, 2024

Related U.S. Application Data
(63) Continuation of application No. PCT/CN2022/098831, filed on Jun. 15, 2022.

(30) Foreign Application Priority Data
Oct. 29, 2021 (CN) 202111274299.6
Dec. 11, 2021 (CN) 202111512533.4
Mar. 24, 2022 (CN) 202210296414.8

(51) Int. Cl. B43K 24/08

(52) U.S. Cl. CPC B43K 24/08

(57) ABSTRACT

A mechanical pencil and an operating method therefor. A position-based relationship of a tool body is determined by means of the displacement of an adjustment part provided in a sleeve. The tool body has two position-based states, which are retracted and propelled states, and the adjustment part achieves relative stability at the two position-based states by means of a positioning part or a positioning slot in the sleeve, a resetting part, and a control part. The resetting part is driven by the tool body to provide a continuous force to the adjustment part, so that the state of a displacement part on the adjustment part is relatively stable at a retracted position. When the displacement part moves in the positioning slot to a propelled position, the displacement part is limited by the control part, so that the state at the propelled position is relatively stable.

### CROSS-REFERENCE TO RELATED APPLICATIONS

This application is a continuation of International Patent Application No. PCT/CN2022/098831 filed on Jun. 15, 2022, which claims the benefit of priority from Chinese Patent Application No. 202111274299.6, filed on Oct. 29, 2021; Chinese Patent Application No. 202111512533.4, filed on Dec. 11, 2021; and Chinese Patent Application No. 202210296414.8, filed on Mar. 24, 2022. The content of the aforementioned applications, including any intervening amendments thereto, is incorporated herein by reference.

### TECHNICAL FIELD

The present invention relates to a pencil.

### BACKGROUND TECHNOLOGY

Currently, with the rapid development of the society, pencils whose leads can be retracted by touch become commercially available, however, structures of some mechanical pencils are complex, in other cases, the mechanical pencils can only trigger lead retraction while cannot realize lead retraction by pulling at the same time, for example, CN2020115121926 disclosed a 360° trigger structure and a pencil with such structure; wherein with such trigger structure, trigger lead retraction for 360° of a mechanical pencil can be realized, excellent functions of nearly automatic lead retraction can be achieved, the effects are good, and can reflect quick change of the new time and significant upgrade of operation methods of mechanical pencils, operation experience of pencils are improved and with the mechanical technology intelligentization is realized; however, although the joint bearing used in the present technical solution is the most stable and popular structure in 360° screw mechanisms currently available, the mature technology means high manufacturing cost and big manufacturing difficulty for 360° lead retraction triggering.

Although there are a plurality of manners to retract the leads in the cited documents, for the innovative structural design, while good technical effects is obtained, the force required for lead retraction triggering is big, consequently, genuinely minor force lead retraction triggering cannot be done while promising stability during usage.

### SUMMARY OF INVENTION

The purpose of the present invention is to provide a mechanical pencil with good flexibility and stability, and when being manufactured in a large quantity, high yields and trigger and pulling lead retraction can be promised.

To realize the foregoing technical purpose, the present invention uses the following technical solutions:

A mechanical pencil, comprising a sleeve, an adjusting part, a tool body, a resetting part and a control part; wherein a displacement part is provided on the adjusting part, and the displacement part is movable in a positioning slot; by configuring displacement of the adjusting part in the sleeve, a position status of the tool body is dictated, and the tool body has two states, namely, lead retracted and lead driving, and the adjusting part realizes relative stability of the two position states by the positioning slot, the resetting part and the control part; with the resetting part, a state of the displacement part on the adjusting part where a lead is retracted is relatively stable; when being moved to the lead driving position, the displacement part in the positioning slot controls the state of the displacement part the lead retracted position to be stable; wherein methods to retract the lead at least comprise to influence movement of the control part by applying an external force, to free the displacement part from limitation of the control part, so that the displacement part will move due to influence of the resetting part, the lead is retracted.

Further, the mechanical pencil further comprises a positioning part, a trigger assembly is provided on the sleeve, by transmission of the trigger assembly, the control part moves to retract the lead; the positioning slot is provided in the positioning part; a lead driving lug and a lead retraction switch ramp are provided in the positioning slot;

Wherein freeing the displacement part from limitation of the control part is realized by using any of the following technical solutions:
(1) Lead retraction solution one: a limiting lug is provided on a control bar; a long limiting ramp is provided in the positioning slot, the limiting lug replaces the control bar to limit the displacement part; when retracting the lead, the displacement part goes up or down, by switching the long limiting ramp and the lead retraction switch ramp the displacement part is free from limitation of the limiting lug, subsequently, the displacement part returns to the lead retracted position via the lead retraction switch ramp;
(2) Lead retraction solution two: the limiting lug is provided on the control bar; the long limiting ramp is provided in the positioning slot, the limiting lug replaces the control bar to limit the displacement part; a return assistance slope is provided on the limiting lug; the displacement part goes up or down, and reaches above or underneath the limiting lug by the lead retraction switch ramp, subsequently, the displacement part goes beyond limitation of the limiting lug by the return assistance slope, and returns to the lead retracted position via the lead retraction switch ramp;
(3) Lead retraction solution three: the limiting lug and a return control slope are provided on the control bar; the limiting lug replaces the control bar to limit the displacement part; when the control bar moves down, the displacement part is subjected to influence of the resetting part and moves upwards, and the displacement part returns to the lead retracted position via the return control slope;
(4) Movement controlled lead retraction: by forcing the control part to move with external forces to free the displacement part from limitation of the control part, the displacement part will thereafter being influenced by the resetting part to move up or down, so to release limitation of the control part on the displacement part, the displacement part can return to the lead retracted position via the lead retraction switch ramp so as to retract the lead;
(5) Pushing lead retraction: a push assistance slope is provided on the displacement part and/or the lead driving lug; maintaining the sleeve still, pulling the adjusting part to move down with external forces, with the push assistance slope, freeing the displacement part from limitation of the lead driving lug and returning to where the lead the retracted.

Further, a lateral pushing portion is provided on the adjusting part; a lateral pushing slot for allowing the lateral pushing portion to slide is provided on the sleeve; a slip-proof boss is provided in the positioning slot, and a fall back passage is provided in between the limiting lug and the slip-proof boss or an inner wall of the sleeve and the limiting lug;

A lead retraction limiting ramp and a lead retraction assistance ramp are provided in the positioning slot;

Lateral pushing lead retraction solution one: applying external forces to push the adjusting part to move down, the displacement part will move down, subsequently, the displacement part will bypass limitation of the lead driving lug via the lead retraction assistance ramp in the positioning slot and return to a lead retracted position A under action of resilience of the resetting part.
further, the trigger assembly comprises a limiting part, a trigger ring and a trigger cover;
the limiting part passes the trigger cover and is connected with the control part, the control part moves along with the limiting part; by pressing the trigger ring with external forces, the trigger ring will press on the trigger cover, so that the trigger cover is pressed against the control part, the control part will have the displacement part to move inwards, so the displacement part is released from the lead driving lug and the displacement part is returned to the lead retracted position via the resetting part.

Further, the trigger assembly is realized by at least the following three manners:
(1) The trigger assembly comprises the limiting part, the trigger ring and the trigger cover; the limiting part passes the trigger cover and is connected with the control part, the control part moves along with the limiting part; the trigger cover is connected with the sleeve; the trigger ring is located in between the limiting part and the trigger cover; at least one trigger assistance diagonal ring is provided underneath the limiting part, above the trigger ring, underneath the trigger ring and/or above the trigger cover;
(2) A connection body is provided on the sleeve; the trigger assembly comprises the limiting part, the trigger ring and the trigger cover; the limiting part passes the trigger cover and is connected with the connection body, the trigger cover passes the connection body and is connected with or abutted against the control part; when the trigger cover moves downwards, the control part moves downwards subsequently; the trigger ring is located in between the limiting part and the trigger cover; at least one trigger assistance diagonal ring is provided underneath the limiting part, above the trigger ring, underneath the trigger ring and/or above the trigger cover; or
(3) The trigger assembly comprises the limiting part and the trigger ring; the limiting part passes the sleeve and is connected with the control part, the control part moves along with the limiting part; the trigger ring is located in between the limiting part and the sleeve; at least one assistance diagonal ring is provided on the limiting part, the trigger ring and/or the sleeve.

Further, solutions for moving the displacement part from the lead retracted position to a lead driving position in the positioning slot can be done in at least the following three manners:
(1) The long switch ramp is provided in the positioning slot, wherein at least one lead driving assistance slope is provided at an end of the lead driving lug close to the lead retracted position and/or an end of the displacement sheet close to the lead driving position, the displacement part is capable of forward and backward deformation and bending, wherein the displacement sheet passes the lead driving lug, with the lead driving assistance slope and the deformation and bending ability of the displacement part, the lead driving lug can be bypassed and the displacement part can reach the lead retracted position;
(2) The long switch ramp and a lead driving sliding wall are provided in the positioning slot, a lead driving guiding ramp is provided in a side of the lead driving lug close to the lead driving position; a lead driving channel is provided in between the long switch ramp and the lead driving lug; when moving from the lead retracted position, the displacement part is subjected to influence of the lead driving guiding ramp and enters the lead driving channel, subsequently, reaches above or underneath the lead driving position via the long switch ramp, at this time, releasing the external forces, the displacement part will return to the lead driving position;
(3) The long switch ramp is provided in the positioning slot, the lead driving sliding wall is provided on the lead driving lug, the lead driving channel is provided on the lead driving lug close to the lead retracted position; when moving from the lead retracted position, the displacement part enters directly the lead driving channel, subsequently, reaches above or underneath the lead driving position via the long switch ramp, at this time, releasing the external forces and the displacement part will return to the lead driving position.

Further, the displacement part has two stable positional relationships when being in the positioning slot:

The lead retracted position, the displacement part is located at the lead retracted position in the positioning slot influenced by the force of the resetting part;

The lead driving position, at this time, the displacement part is subjected to the limitation of the control part to overcome the force of the resetting part, and the displacement sheet is located stably at the lead driving position in the positioning slot.

Further, solutions for moving the displacement part leftwards or rightwards in the positioning slot can be found by using at least the following eight solutions:
(1) A movable slot is provided in the displacement part, at least one sliding ball is provided in between the movable slot and the positioning slot; the at least one sliding ball, instead of the displacement sheet contacts directly the positioning slot;
(2) A displacement clip, a sliding ball slot or a rotation lug is further provided on the displacement part, at least one sliding ball is provided in between the sliding ball slot and the positioning slot; a revolution part is provided on the rotation lug, and an end of the revolution part is sleeved over the rotation lug, the revolution part is rotatable relative to the rotation lug, a displacement portion is provided at another end of the revolution part, and the displacement portion, the at least one sliding ball or the displacement clip, instead of the displacement part, contacts directly the positioning slot;
(3) The displacement clip, the sliding ball slot or the rotation lug is provided on the displacement part, at least one sliding ball is provided in between the sliding ball slot and the positioning slot; the revolution part is provided on the rotation lug, an end of the revolution part is sleeved over the rotation lug, the revolution part is rotatable relative to the rotation lug, the displacement portion is provided at another end of the revolution part, the displacement portion, the at least one sliding ball or the displacement clip, instead of the displacement part, contacts directly the positioning slot; the displacement part has deformation and bending capability, and can be bent, so to have the displacement part to move leftward or rightward in the positioning slot while the adjusting part remains stable;
(4) The displacement clip, the sliding ball slot or the rotation lug is provided on the displacement part, at least one sliding ball is provided in between the sliding ball slot and the positioning slot; the revolution part is provided on the rotation lug, an end of the revolution part is sleeved over the rotation lug, the revolution part is rotatable relative to the rotation lug, a displacement portion is provided on another end of the revolution part, and the displacement portion, the at least one sliding ball or the displacement clip, instead of the displacement part, contacts directly the positioning slot; when to move leftward or rightward, the adjusting part will be moved leftward or rightward;
(5) The displacement part is independent from the adjusting part to be an independent part, the displacement clip, the sliding ball slot, the movable slot or the rotation lug is provided on the displacement part, at least one sliding ball is provided in between the movable slot or the sliding ball slot and the positioning slot; the revolution part is provided on the rotation lug, an end of the revolution part is sleeved over the rotation lug, the revolution part is rotatable relative to the rotation lug, the displacement portion is provided at another end of the revolution part, and the displacement portion, the at least one sliding ball or the displacement clip, instead of the displacement part contacts directly the positioning slot; and the displacement part engages with the adjusting part by magnetic absorption, clearance fit, abrasives, threaded connection and/or engagement via a third party member;
(6) The rotation lug is provided on the displacement part, the revolution part is provided on the rotation lug, an end of the revolution part is installed on the rotation lug, so that the revolution part is rotatable relative to the rotation lug, the displacement portion is provided at another end of the revolution part, and the displacement portion, instead of the displacement part, contacts directly the positioning slot;
(7) A rotation through-hole is provided in the displacement part, the revolution part is provided in the rotation through-hole, the revolution part is rotatable relative to the rotation through-hole, the displacement portion is provided at another end of the revolution part and the displacement portion, instead of the displacement part, contacts directly the positioning slot;
(8) With the assistance of the third-party member, the displacement part can move leftward or rightward in the positioning slot.

Further, an auxiliary resetting part is provided in between the control part and the adjusting part; or the auxiliary resetting part is provided in between the control part and the sleeve; an adjusting hole is provided at a structure connected with the tool body, and an adjustable base is provided in the adjusting hole;

A plurality of layers of dislocated designs are provided in the positioning slot;

An installation cushioning groove and/or lead retraction tolerance groove is provided in the positioning slot;

Where the positioning slot is provided in the sleeve, the lead retraction limiting wall is provided on the sleeve;

An extension bar can be extended and provided on a lower end of the control part;

Where the displacement part is not substituted by using the at least one sliding ball, the revolution part or the third-party member, the displacement part appears to be an overhead hook.

Further, when the lead retraction solution one is used, the control switch wall is further provided on the control part; the lead retraction channel is provided in between the limiting lug and the long switch ramp and/or the lead retraction channel is provided in between the limiting lug and the control switch wall;

When the lead retraction solution two is used, the lead retraction channel is provided in between the control part and the long switch ramp.

Further, in the solution seven, a rotation stabilizing lug is providing on the adjusting part; a rotation abutment boss for colliding and adjusting the revolution part is provided on the displacement part and/or a abutment lug for colliding and adjusting the revolution part is provided on the positioning part; a rotation assistance lug and/or a rotation installation notch is provided on the revolution part; a deformation groove is provided on the lead driving lug, the positioning part, the displacement part, the sleeve and/or the rotation abutment lug.

Further, a rotation stopper is provided on the displacement part, the rotation lug, the rotation through-hole and/or the revolution part.

Further, an outer diameter of the trigger ring is bigger than an outer diameter of the sleeve; a diagonal trigger plane is provided underneath the trigger ring; the auxiliary resetting part is provided in between the control part and the positioning part; when the positioning slot is provided in the positioning part, the lead retraction limiting wall is provided in the positioning slot or an inner wall of the sleeve functions equivalently to the lead retraction limiting wall.

The technical solutions in the foregoing invention have the following beneficial effects:
(1) In light of stability at the lead driving position, stability at the lead retracted position, stability and smoothness of switching from lead driving to lead retracted, and stability and smoothness of switching from lead retracted to lead driving, integrity and stability of appearance, compactness and optimization of internal space, and a conversion ratio of adjustment of force required for triggering, comprehensive optimization and improvement to the pencil has been done.
(2) By means of structural optimization, resetting without using foreign objects is achieved, the minimum force required for triggering is reduced, the trigger effects are significantly improved, the usage experience is greatly enhanced, and trigger lead retraction is realized to a better extent.
(3) By structural integration and optimization of foreign object free resetting, a better effect of reducing the cost and the assembly difficulty is achieved.
(4) By improving a structural utility rate, pulling lead retraction and trigger lead retraction is achieved in the meanwhile, and both lead retraction ways have significant commercial values and bring very good user experience, and requirements of different users can be satisfied.
(5) More external trigger forces can be transmitted to realize trigger lead retraction to a higher extent.
(6) In the present invention, the technical solution of lead retraction triggering is mature, and the force required for lead retraction triggering is several times smaller than that required for common lead retraction solutions, the trigger is highly efficient, the triggering effects are better, which results from the fact that the present invention has chosen a different way to configure a lead retraction boss to bear most of elastic force of the resetting part, and uses the control part to limit the adjusting part or the displacement part from departing from the lead driving sliding wall, at this time, the control part functions as a switch, and bears only a small part of the pressure formed by the elastic force of the resetting part, by withdrawing the control part, a passage for returning is released, the displacement part can be returned to the lead retracted position via the lead driving sliding wall and the resetting part; furthermore, in the present invention, the friction on the surface of the control part is not to be considered, therefore, the smaller the friction on the surface of the control part is, the smaller the force required for triggering is, and the more flexible the touch is.
(7) In the further technical solutions, the rotation lug is eccentrically configured, in this way, the utility rate of the internal space is further improved, so that while the internal space is further reduced, stability of operations is promised; by using the revolution part and the rotation lug, interference due to gravity can be overcome, and translation or rotation of the displacement part is perfectly solved, the integrity, the durability and the reliability of the internal structures can be improved to a greater extent, and the operation smoothness and the touch flexibility can be improved to a large extent.
(8) In the further technical solutions, the trigger ring is provided with the triggering diagonal plane, and the triggering effects are better improved.
(9) In the further technical solution, the positioning slot is provided in the positioning part, the manufacturing and fabrication difficulty is further reduced, what's more, the difficulty in replacing parts can be reduced, in the meanwhile, planar positioning slots can be made, for current technologies, it is easier to machine planar planes than curved planes, accuracy and actual effects of the planar planes can be superior to those of the curved planes, the operation smoothness and stability can be further improved.
(10) In the present invention, the lead retraction triggering solution one is mature, and the force required for lead retraction triggering is lower, the lead retraction triggering is more efficient, the retraction effects are better, which attributes to the fact that, the present invention chooses to bear most of the elastic force of the resetting part via the lead driving lug and uses the control part to limit the adjusting part or the displacement part from falling off the lead driving sliding wall, at this time, the control part functions equivalently to a switch, and bears only a minor part of pressure formed by the elastic force of the resetting part, by removing the control part to release the passage for return, the displacement part can be returned to the lead retracted position via the lead driving sliding wall and the resetting part.
(11) With the technical solution of the movable slot and the at least one sliding ball, the rotation or translation of the displacement part can be solved to a better extent, the integrity, durability and stability of the internal structures can be raised to a further extent, and the operation smoothness and touch flexibility can be greatly improved; during sliding, interference from gravity may be present, however, by increasing friction among parts, adding liquids of a high viscosity, adding at least one magnet to attract the at least one sliding ball, and making one-way limiting to prevent the at least one sliding ball from moving back and forth and/or using misaligned design in a plurality of layers to prevent the at least one sliding ball from moving back and forth, the problem can be solved.

### BRIEF DESCRIPTION OF DRAWINGS

FIG. 1 is a front view diagram showing a locally cross section view of an embodiment 1 of the present invention.

FIG. 2 is a cross section diagram at B-B of FIG. 1 according to the present invention.

FIG. 3 is a locally enlarged diagram of a part marked “B” in FIG. 1 according to the present invention.

FIG. 4 is a left-side view diagram showing the locally cross section view of the embodiment 1 of the present invention.

FIG. 5 is a cross sectional diagram at C-C in FIG. 4 according to the present invention.

FIG. 6 is an exploded perspective diagram showing the embodiment 1 of the present invention.

FIG. 7 is another exploded perspective diagram showing the embodiment 1 of the present invention.

FIG. 8 is a front view diagram showing an embodiment 2 of the present invention.

FIG. 9 is a locally enlarged diagram showing an area marked “D” in FIG. 8 according to the present invention.

FIG. 10 is a cross-section diagram showing D-D in FIG. 9 according to the present invention.

FIG. 11 is a left side diagram showing the embodiment 2 according to the present invention.

FIG. 12 is a cross-section diagram showing E-E in FIG. 11 according to the present invention.

FIG. 13 is a perspective diagram showing the embodiment 2 of the present invention.

FIG. 14 is a perspective diagram showing an embodiment 3 of the present invention.

FIG. 15 is a locally enlarged diagram showing a part marked “F” in FIG. 14 according to the present invention.

FIG. 16 is a locally enlarged diagram at F-F in FIG. 14 of the present invention.

FIG. 17 is a locally enlarged diagram showing a part marked “R” in FIG. 16 according to the present invention.

FIG. 18 is an exploded perspective diagram showing the embodiment 3 of the present invention.

FIG. 19 is a front view diagram showing a local cross-section of the embodiment 3 of the present invention.

FIG. 20 is a cross-sectional diagram at I-I in FIG. 19 of the present invention.

FIG. 21 is a locally enlarged diagram showing FIG. 20 of the present invention.

FIG. 22 is a cross-section diagram at M-M in FIG. 20 of the present invention.

FIG. 23 is an exploded perspective diagram showing an embodiment 4 of the present invention.

FIG. 24 is a front view diagram showing an embodiment 5 of the present invention.

FIG. 25 is a cross-section diagram at A-A of FIG. 24 according to the present invention.

FIG. 26 is a front view diagram showing the embodiment 5 of the present invention.

FIG. 27 is a cross-section diagram at U-U of FIG. 26 according to the present invention.

FIG. 28 is a front view diagram showing an embodiment 6 of the present invention.

FIG. 29 is cross-section diagram at K-K of FIG. 28 according to the present invention.

FIG. 30 is a cross-section diagram at P-P of FIG. 28 according to the present invention.

FIG. 31 is a locally enlarged diagram at a part marked “A” in FIG. 30 according to the present invention.

FIG. 32 is an exploded perspective diagram showing the embodiment 6 of the present invention.

FIG. 33 is a left-side diagram showing an embodiment 7 of the present invention.

FIG. 34 is a cross-section diagram at N-N of FIG. 33 according to the present invention.

FIG. 35 is an exploded perspective diagram showing the embodiment 7 of the present invention.

FIG. 36 is another exploded perspective diagram showing the embodiment 7 of the present invention.

FIG. 37 is a front view diagram showing a locally cross section of an embodiment 8 of the present invention.

FIG. 38 is a cross-sectional diagram at S-S of FIG. 37 of the present invention.

FIG. 39 is a locally enlarged diagram at SA of FIG. 38 of the present invention.

FIG. 40 is an exploded perspective diagram showing an embodiment 8 of the present invention.

FIG. 41 is another exploded perspective diagram showing the embodiment 8 of the present invention.

### EMBODIMENTS

Hereinafter a further description will be given to the present invention in conjunction with the drawings.

### Embodiment 1

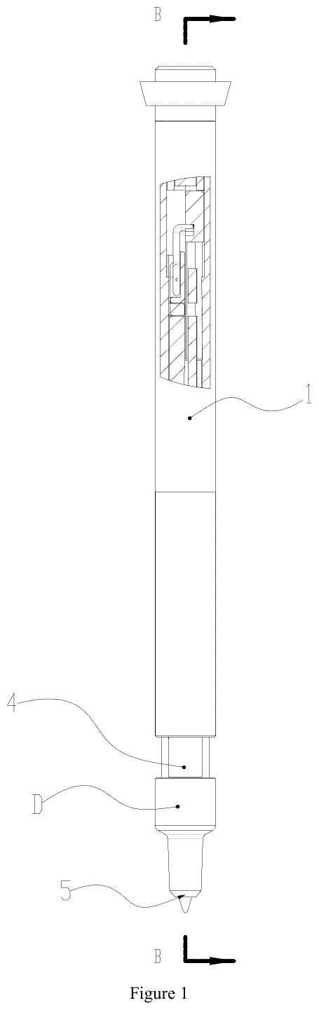

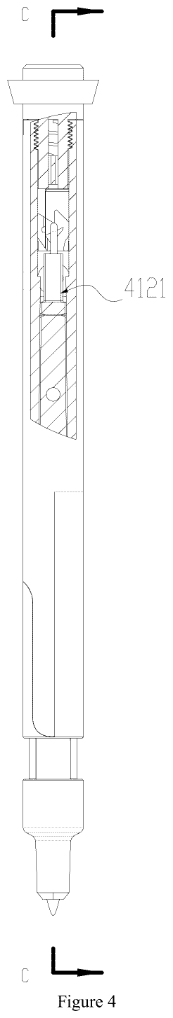

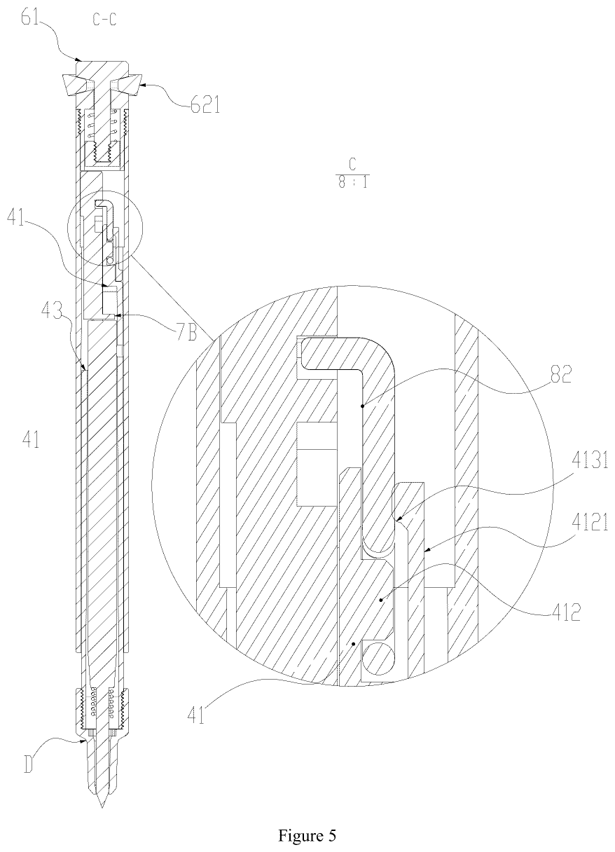

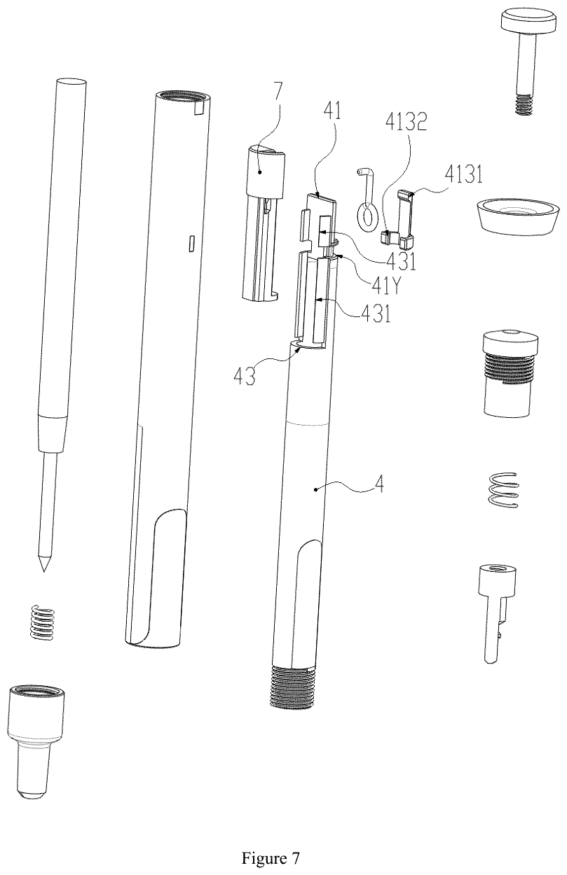

a mechanical pencil as shown in FIGS. 1-7, comprising a sleeve 1, a resetting part 3, a tool body 5 and an adjusting module. The adjusting module comprises a control part 2, an adjusting part 4 and a positioning part 7.

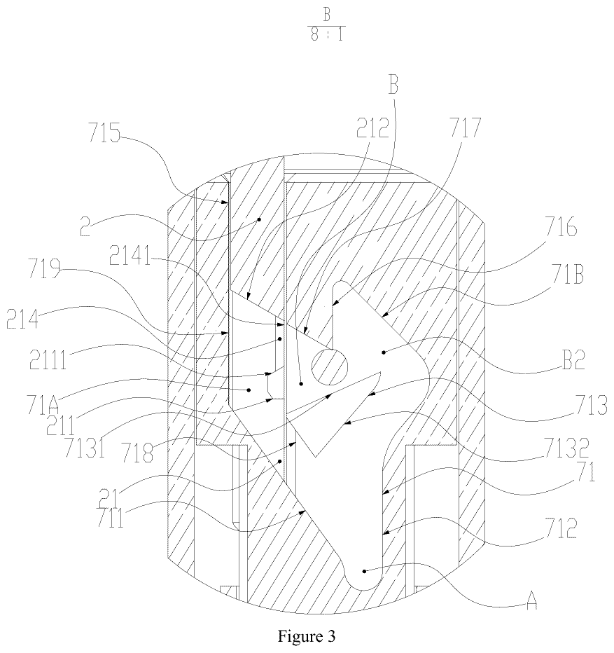

The positioning part 7 is installed in the sleeve 1, a positioning slot 71 is provided in the positioning part 7; and a control bar 21 is provided on the control part 2. A displacement part 41 is provided on the adjusting part 4, the displacement part 41 is movably provided in the positioning slot 71. A tail portion of the tool body 5 is abutted against the positioning part 7, a part of the tool body is placed in the adjusting part 4 and the resetting part 3 is completely placed in the adjusting part. As shown in FIG. 3, a lead retraction switch wall 711, a long switch ramp 71B and a lead retraction boss 713 are provided in the positioning slot 71. And a lead retraction sliding wall 7131 is provided on the lead retraction boss 713.

A bottom portion of the lead retraction switch wall 711 comprises a lead retraction area A, at this time, the tool body 5 is hidden completely in the adjusting part 4, when the lead is retracted. As shown in the drawings, the tool body 5 is preferably a common pencil lead and the resetting part 3 is preferably a spring.

As shown in FIG. 3, when the displacement part 31 is rested on the lead driving sliding wall 7131, subjected to influence of the lead driving sliding wall 7131 and the resetting part 3 the displacement part 41 will move along an inclination direction of the lead driving sliding wall 7131, and before leaving the lead driving sliding wall 7131 completely, the displacement part 41 is limited by the control bar 21 and finally the displacement part 41 will remain on the lead driving sliding wall 7131, at this time, a position where the displacement part 41 is a lead driving position B. At this time the lead is driving.

A way to extend and retract the lead with the control bar 21: a limiting lug 211 and a control switch wall 212 are provided on the control bar 21, and the limiting lug 211, instead of the control bar 21, limits the displacement part 41. A lead retraction channel 214 is provided in between the limiting lug 211 and the control switch wall 211. When to retract the lead, the displacement part 41 moves upwards, and with the lead retraction channel 214 and the lead retraction switch wall 711 the displacement part 41 will be freed from limitation of the limiting lug 211 and return to the lead retracted position A. A solution for moving the displacement part 41 leftward or rightward in the positioning slot 71, wherein a rotation lug 412 is provided on the displacement part 41, a revolution part 82 is provided on the rotation lug 412, an end of the revolution part 82 is sleeved over the rotation lug 412, the revolution part 82 is rotatable relative to the rotation lug 412, a displacement portion 821 is provided at another end of the revolution part 82, and the displacement portion 821, instead of the displacement part 41, contacts directly the positioning slot 71. The displacement part 41 is not to be turned leftward or rightward, when to move leftward or rightward, rotate the revolution part 82 relative to the rotation lug 412.

A solution for moving the displacement part 41 in the positioning slot 71 from the lead retracted position A to the lead retracted position B, a lead driving guiding ramp 7132 is provided on the lead driving lug 713 close to the lead retracted position A. A leading driving passage B2 is provided in between the long switch ramp 71B and the lead driving lug 713. When moving the displacement part 41 to the lead retracted position A, subjected to the influence of the lead driving guiding ramp 7132, the displacement part 41 to the lead driving channel B2, subsequently reaches above the lead driving position B, at this time, release the external force, the displacement part 41 will return to the lead driving position B.

Specifically, as shown in FIG. 3, when the long switch ramp 71B is provided in the positioning slot 71, a lead retraction limiting ramp 716 and a lead retraction assistance ramp 717 can be provided in the positioning slot 71. The lead retraction limiting ramp 716 is primarily configured to limit the displacement part 41, to prevent the displacement part 41 from moving up too much, which may result in that the displacement part 41 cannot be maintained at the lead driving position B. When the long switch ramp 71B is stopped by the lead driving limit wall 716, a length of the long switch ramp 71B is not sufficient for supporting the displacement part 41 to propel the lead, the lead retraction assistance ramp 717, instead of the long switch ramp 71B, assists the displacement part 41 to retract the lead by pulling the lead back.

To realize lead retraction triggering, a trigger assembly 6 is provided on the sleeve 1, by controlling movement of the control part 2 with the trigger assembly 6, the trigger methods, trigger directions, trigger forces required and trigger scope of the control part 2 can be changed. The trigger assembly 6 comprises a limiting part 61, a trigger ring 62 and a trigger cover 63. The limiting part 61 passes the trigger cover 63 and is connected with the control part 2, and the control part 2 moves along with the limiting part 61. The trigger cover 63 and the sleeve 1 are interconnected. The trigger ring 62 is located in between the limiting part 61 and the trigger cover 63. At least one trigger assistance diagonal ring C is provided underneath the limiting part 61, above the trigger ring 62, underneath the trigger ring 62 and/or above the trigger cover 63.

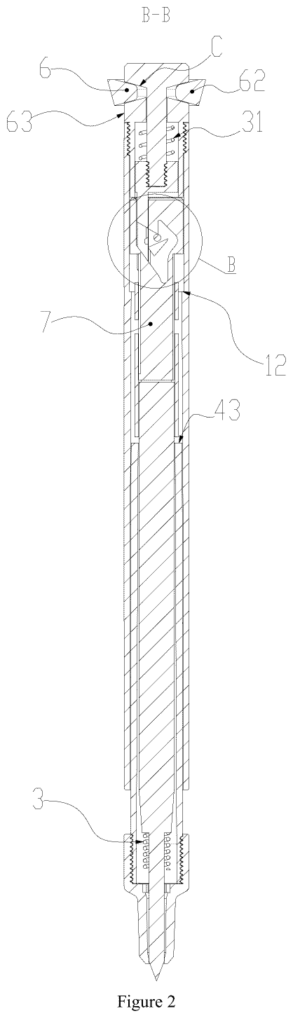

To increase the stability of the trigger assembly 6, when the pencil is inclined, triggering can be done stably, and an auxiliary resetting part 31 is provided in between the control part 2 and the sleeve 1. According to FIG. 2, the auxiliary resetting part 31 comprises a spring.

To ensure easy triggering, an outer diameter of the trigger ring 62 is bigger than an outer diameter of the sleeve 1. A trigger diagonal plane 621 is provided underneath the trigger ring 62. Frictions of the control part and/or the trigger ring are the smaller, the better. An inclination angle of the trigger diagonal plane is dictated by a predetermined trigger inclination angle, for example: when inclining for 10°, triggering can be done, the inclination angle of the diagonal plane is more than 10° so as to improve trigger effects. To ensure that the control part 2 can function as the control part, both the control part 2 and the sleeve 1 can move vertically rather than horizontally, and a downward movement threshold is configured.

An auxiliary passage slope 2141 is provided at a side of the lead retraction channel 214 close to the lead driving area B.

To guarantee falling stability, a fall-proof boss 719 is provided in the positioning slot 71, and a return passage 71A is provided in between the limiting lug 211 and the fall-proof boss 719 or an inner surface of the sleeve 1 and the limiting lug 211.

To have the control bar to play a better role, a control slot 715 for allowing the control bar 21 to move vertically is provided on the positioning part 7. The control bar 21 passes the control slot 715 to limit the displacement portion 821 of the revolution part 82 from leaving the lead driving sliding wall 7131. Preferably, the control slot 715 and the control bar 21 are extended to the same level as the lead retracted position A, at this time, even when the control bar 21 is moved upwards subjected to the influence of the trigger assembly 6, at the moment of triggering, the displacement portion 821 enters the lead retraction switch wall 711 when releasing the control bar 21, a displacement opening for the control bar 21 will not appear in between the control bar 21 and the lead retraction switch wall 711, the entire operation system is more reliable, and the displacement portion 821 will not fall into the displacement opening for the control bar 21. A sliding assistance slope 718 for having the displacement part 41 to slide in is provided in the positioning slot 71, in consideration of jamming of the displacement part 41 due to the control slot 715, by configuring the sliding assistance slope 718 the jamming during return can be addressed. The control slot 715 can also serve as an installation sliding channel for the displacement portion 821 to ease the assembly.

A lower end point of the control switch wall 212 is higher than an upper end point of the lead retraction assistance ramp 717, and in this way a better technical effect can be achieved.

To further improve the tolerance of return of the displacement part 41, a return limiting slope 2111 is provided on the limiting lug 211.

At least one movable opening 43 is provided on the adjusting part 4; at least one clamping extension 431 is provided on the at least one movable opening 43, the at least one clamping extension 431 is adaptive to the positioning part 7, when the positioning part 7 is clamped onto the at least one clamping extension 431, the adjusting part 4 can be limited to make only up and down movement, even when the positioning part 7 is not installed in the sleeve 7, engagement with the adjusting part 4 is not liable to loosen; the at least one movable opening 43 is configured to house the positioning part 7, although the positioning part 7 is not movable, the adjusting part 4 will move relative to the positioning part 7, in some cases in embodiments of the present invention, the positioning part 7 is to enter the adjusting part 4, therefore, in such cases, the at least one movable opening 43 is to be reserved for the positioning part 7 to adjust a movement range of the adjusting part 4;

To ensure that after assembly, the sleeve and the adjusting part are not liable to separate from each other, a positioning limiting lug 7B is provided on the positioning part 7; the positioning limiting lug 7B can be used to fix the tool body 5, in the meanwhile, the positioning limiting lug 7B can limit the tool body 5 together with the displacement part 41, before assembly, the positioning limiting lug 7B is inserted into the adjusting part 4 laterally, after assembly, the adjusting part 4 can only make vertical movements, therefore, the positioning limiting lug 7B cannot leave the adjusting part 4 via up and down movement, and with engagement between the positioning part 7 and the sleeve 1, separation of the adjusting part 4 and the sleeve 1 can be efficiently avoided.

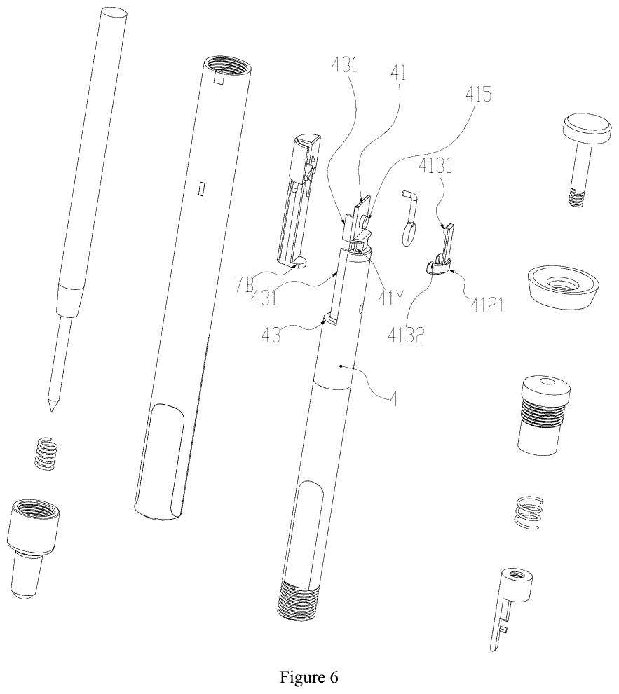

Specifically, as shown in FIG. 6, to fix the revolution part 82, a revolution fixing part 4121 for limiting the revolution part 82 is provided on the displacement part 41, the revolution fixing part 4121 comprises a clamping portion 4131 and a fixing portion 4132. The revolution fixing part 4121 is fixed into the displacement part 41 by inserting the fixing portion 4132, and a clamping fixing slot 41Y is provided on the displacement part 41, after inserting the fixing portion 4132 into the clamping fixing slot 41Y, by applying a clamping force continuously on the revolution part 82 via the clamping portion 4131, leftward or rightward rotation of the revolution part 82 is resisted to some extent so as to overcome interference of the gravity.

An installation method of the pencil:
1. First of all, assembling the positioning part 7, the revolution part 82 and the adjusting part 4, joining one end of the revolution part 82 onto the rotation the rotation lug 412 of the adjusting part, inserting the positioning part 7 into the adjusting part, installing another end of the displacement portion into the positioning slot; the adjusting assembly is done;
2. Thereafter, installing the adjusting assembly into the sleeve 1, the adjusting assembly cannot be moved down too much due to limitation between the positioning part 7 and the sleeve 1, when the positioning part 7 is in position, installing the control part 2, the auxiliary resetting part and the trigger cover into the sleeve sequentially;
3. Thereafter, placing the trigger ring 62 on the trigger cover 63, passing the limiting part 61 through the trigger ring 62 and the trigger cover 63, to be assembled onto the control part 2; assembly of the pencil is nearly done;
4. Finally, installing the tool body 5, the resetting part 3 and a lead replacement portion into the adjusting part, and installing the lead replacement portion and the adjusting part 4.

A method to propel the lead: using the lead driving solution three: controlling the adjusting part 4 to move upwards with an external force, when the displacement part 41 moves from the lead retracted position A, subjected to the influence of the lead driving guiding ramp 7132, the displacement part 41 enters the lead driving channel B2, subsequently, reaches above the lead driving position B via the long switch ramp, at this time, releasing the external force, the displacement part 41 will return to the lead driving position B.

In the meanwhile there are two ways to retract the lead:
1. Trigger lead retraction solution one: placing the product according to the present invention on a desk, in a bag, case or pocket, the trigger ring 62 will be touched by other articles therein, the force generated due to touch will be transmitted to the limiting part 61, the limiting part 61 will move upwards, and drive the control part 2 to move upwards, when the control part 2 moves upwards, the displacement portion 821 is freed from limitation of the control part 2, and will slide from the lead driving sliding wall 7131 to the lead driving position A, and at this time, the tool body will be hidden in the lead replacement portion D;
2. Pulling lead retraction solution one: controlling the adjusting part to move upwards via an external force, with the lead retraction assistance ramp 717 in the positioning part 71 and the control switch wall 212 on the control part 2, the displacement part 41 is freed from limitation of the limiting lug 211 and returns to the lead retracted position A due to influence of the resetting part 3.

### Embodiment 2

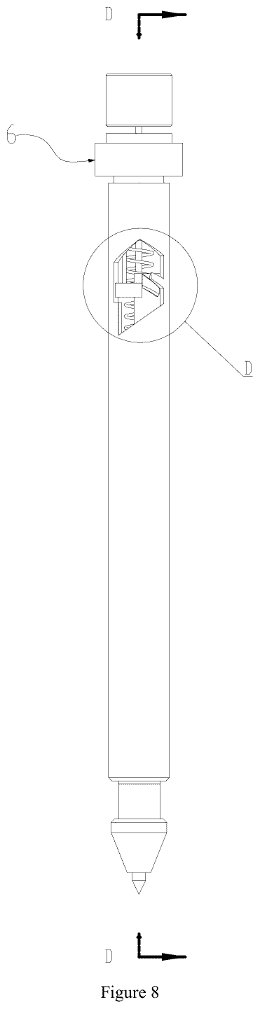

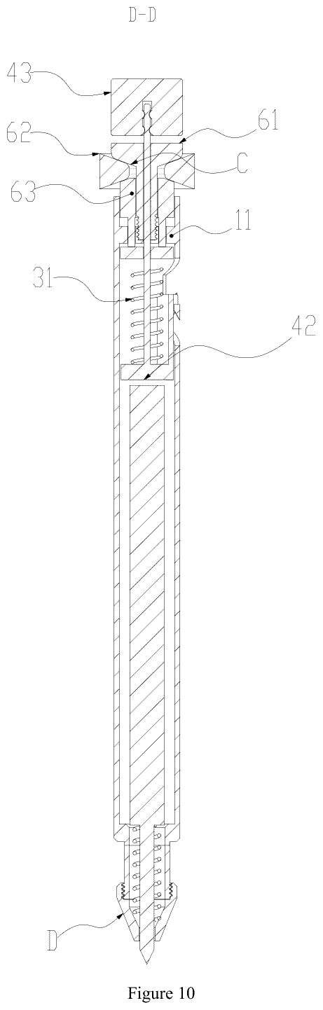

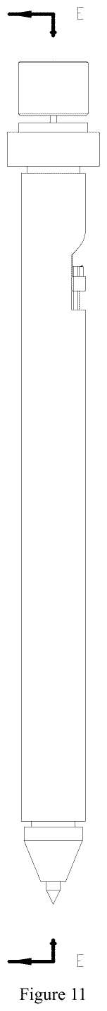

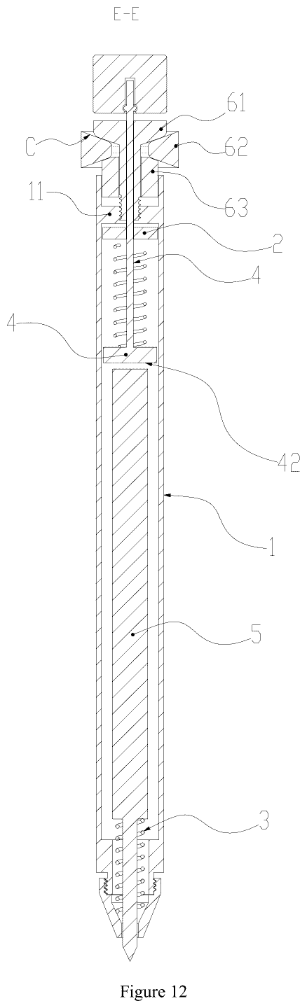

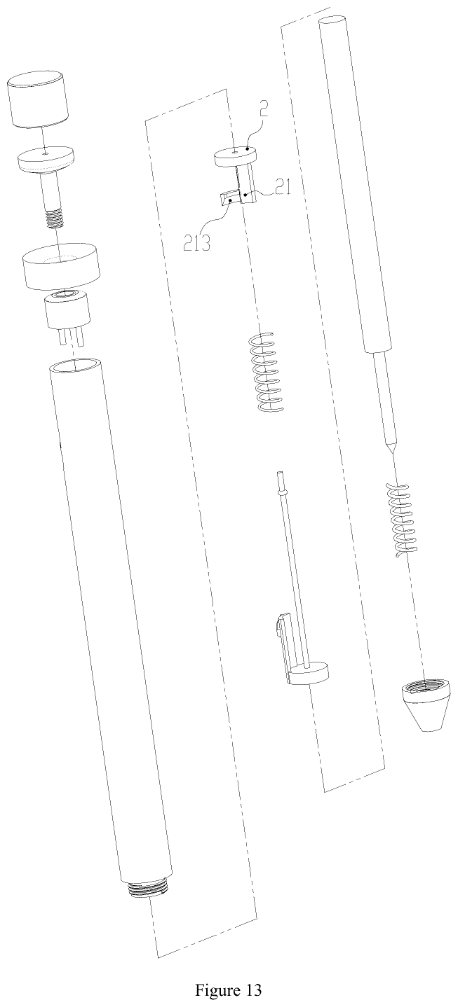

a mechanical pencil as shown in FIGS. 8-13, comprising an sleeve 1, a resetting part 3, a tool body and an adjusting assembly. The adjusting assembly comprises a control part 2 and an adjusting part 4.

A control bar 21 is provided on the control part 2; what is different from embodiment 1 is that, the positioning slot 71 is provided in the sleeve 1, specific structures of the positioning slot 71 and the displacement part 41 are different from those in embodiment. A displacement part 41 is provided on the adjusting part 4, and the displacement part 41 is movable in the positioning slot 71.

Specifically as shown in FIG. 6, when using pressure lead driving and pressure lead retraction solutions, to prevent the lead from moving backward too much, and ensure stability of the entire structure, an adjusting limiting portion 42 is provided on the adjusting part 4. A tail portion of the tool body 5 is rested on the adjusting limiting portion 42, and the tool body 5 and the resetting part are completely outside the sleeve. To improve the overall stability of trigger lead retraction, and ensure that the control part is maintained closest to the lead driving lug 713 in any condition after usage, an auxiliary resetting part 31 is provided in between the control part 2 and the adjusting part 4.

A lead retraction switch wall 711, a long switch ramp 71B and a lead driving lug 713 are provided in the positioning slot 71. The lead driving sliding wall 7131 is provided on the lead driving lug 713.

A bottom portion of the lead retraction switch wall 711 comprises a lead retracted position A, at this time, the tool body 5 is maintained in the adjusting part 4 and the lead is retracted.

When the displacement part 41 is located on the lead driving sliding wall 7131, subjected to the influence of the lead driving sliding wall 7131 and the resetting part 3, the displacement part 41 will move along an inclination direction of the lead driving sliding wall 7131, before departing from the lead driving sliding wall 7131, the displacement part 41 is subjected to the limitation of the control bar 21, finally the displacement part 41 will remain on the lead driving sliding wall 7131, and the position where the displacement part 41 is comprises a lead driving position B. At this time the lead is driving.

A solution for moving the displacement part 41 leftward or rightward in the positioning slot 71, a displacement clip 411 is provided on the displacement part 41. The displacement clip 411, instead of the displacement part 41, contacts directly the positioning slot 71. The displacement part 41 is capable of deformation leftward or rightward and is bendable, so that during moving in the positioning slot 71, while the adjusting part 4 is maintained still, the displacement part 41 can rotate to move leftward or rightward.

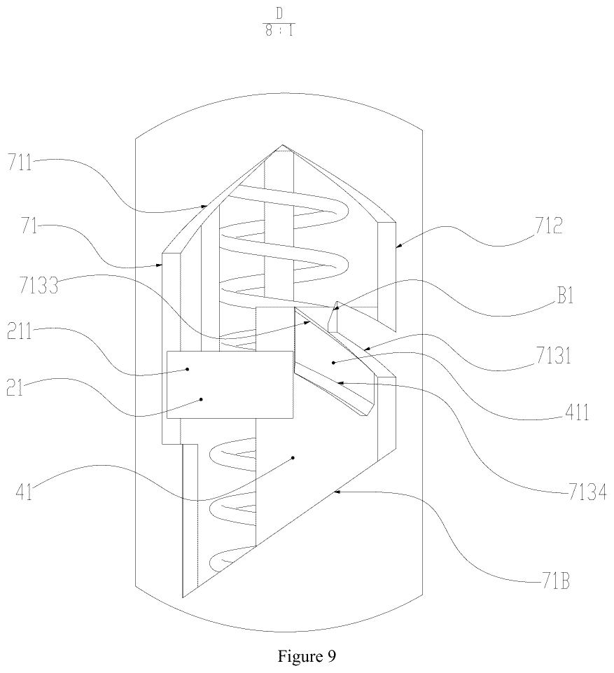

A solution for moving the displacement part 41 in the positioning slot 71 from the lead retracted position A to the lead driving position B, a lead driving assistance slope B1 is provided at an end of the lead driving lug 713 close to the lead retracted position A and/or an end of the displacement part 41 close to the lead driving position B, the displacement part 41 is capable of deformation forward and backward and is bendable, when the displacement part 41 passes the lead driving lug 713m via the deformation and bending capacity of the lead driving assistance slope B1 and the displacement part 41, the displacement part 41 leaves the lead driving lug 713 and reaches the lead driving position B. And positions of A and B are shown in FIG. 9.

To realize trigger lead retraction, a trigger assembly 6 is provided on the sleeve 1, by influencing movement of the control part 2 with the trigger assembly 6, the trigger method, trigger direction, force required for triggering and trigger magnitude of the control part 2 can be changed. A connection body 11 is connected on the sleeve 1. The trigger assembly 6 comprises a limiting part 61, a trigger ring 62 and a trigger cover 63. The limiting part 61 passes the trigger cover 63 and is connected with the connection body 11, and the trigger cover 63 passes the connection body 11 and is connected with or abutted against the control part 2. The trigger cover 63 moves downwards, the control part 2 will be pressed downwards. The trigger ring 62 is provided in between the limiting part 61 and the trigger cover 63. At least one trigger assistance diagonal ring C is provided underneath the limiting part 61, above the trigger ring 62, underneath the trigger ring 62 and/or above the trigger cover 63.

To enhance the stability of the trigger assembly, and to enable triggering when the pencil is inclined, an auxiliary resetting part 31 is provided in between the control part 2 and the sleeve 1.

To promise easier trigger, an outer diameter of the trigger ring 62 is bigger than an outer diameter of the sleeve 1. Frictions of surfaces of the control bar and/or trigger ring are the smaller, the better.

To guarantee that the control part can serve as a control part, only vertical movement between the control part 2 and the sleeve 1 is allowed, leftward or rightward rotation is not permitted, and a maximum upward movement threshold is preset.

To switch from the lead retraction state to the lead driving state: applying an external force, while maintaining the sleeve 1 stable, moving the adjusting part 4, to move the displacement part 41 from the lead retracted position A to underneath the lead driving lug 713, releasing the external force, the displacement part 41 will fall back subjected to the influence of the resetting part 3 and the displacement part 41 will remain at the lead driving position B after being in contact with the lead driving sliding wall 7131 and the control bar 21.

To make it easy to press the pencil, a pressing member 43 is provided and the pressing member 43 engages with the adjusting part.

To make it convenient to fix the auxiliary resetting part, a circular resetting boss 24 is provided on the control part 2, and for embodiment 1 the circular resetting boss 24 can be used too.

### Installation Method:

1. First of all, inserting the trigger cover 63, the trigger ring 62 and the limiting part 61 into the sleeve 1, passing the limiting part 61 through the trigger ring 62 and the trigger cover 63 to engage with the connection body;
2. Installing the positioning part 7, the auxiliary resetting part 31, the adjusting part 4, the lead, the resetting part 3 and the lead replacement portion into the sleeve 1 sequentially, engaging the lead replacement portion with the sleeve 1;
3. Finally engaging the pressing member 43 and the adjusting part 4.

Pressing lead driving solution two: maintaining the sleeve 1 stable, controlling the adjusting part 4 to move downward by applying an external force, when the displacement part 41 passes the lead driving lug 713 the displacement part 41 will bypass the lead driving lug 713 and reach the lead driving position B with the deformation and bending ability of the lead driving assistance slope B1 and the displacement part 41.

In the meanwhile, there are the following two methods to retract the lead:
1. Trigger lead retraction solution one: placing the product according to the present invention on the desk, in the bag, case or pocket, the trigger ring 62 will be touched by other articles, the force generated by touch will be transmitted to the trigger cover 63, the trigger cover 63 will move downwards, so as to drive the control part 2 to move downwards, when the control part 2 moves downwards, the displacement boss 411 will lose limitation on the control part 2, and the control part 2 will slide to the lead retracted position A along the lead driving sliding wall 7131, and at this time, the tool body will be completely hidden in the lead replacement portion D;
2. Pressing lead retraction solution two: controlling the adjusting part 4 to move downwards by applying an external force, moving to underneath the limiting lug 211 via the long switch ramp 71B, releasing the external force, freeing the displacement part 41 from limitation of the control part 2 via the return assistance slope 213 on the control bar 21 and the resetting part 3, thereafter the displacement part 41 is returned to the lead retracted position A.

The other details not given in the present embodiment are the same as those in embodiment 1, and will not be repeated here.

### Embodiment 3

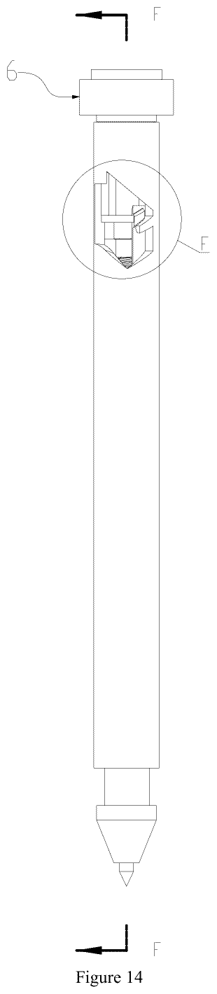

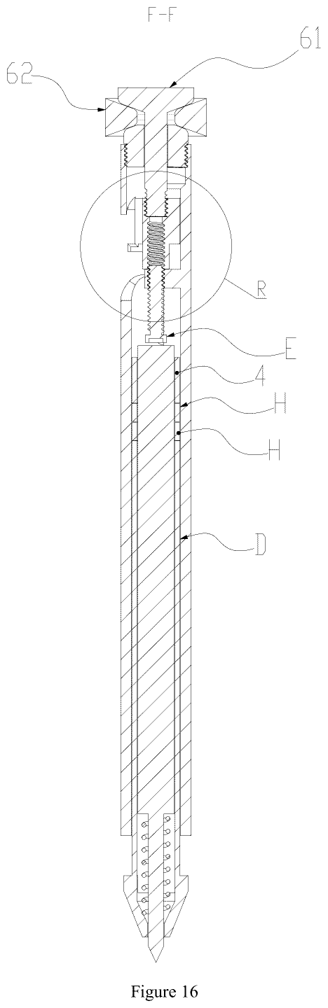

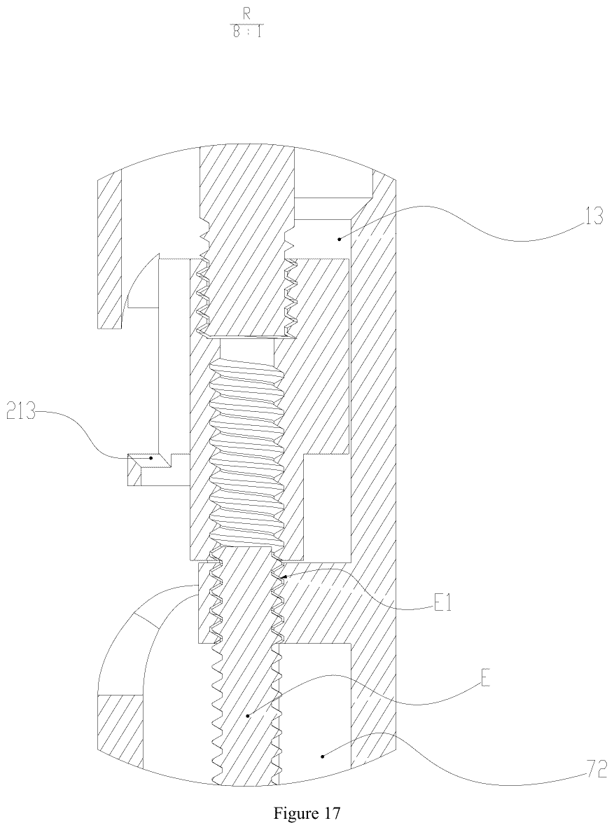

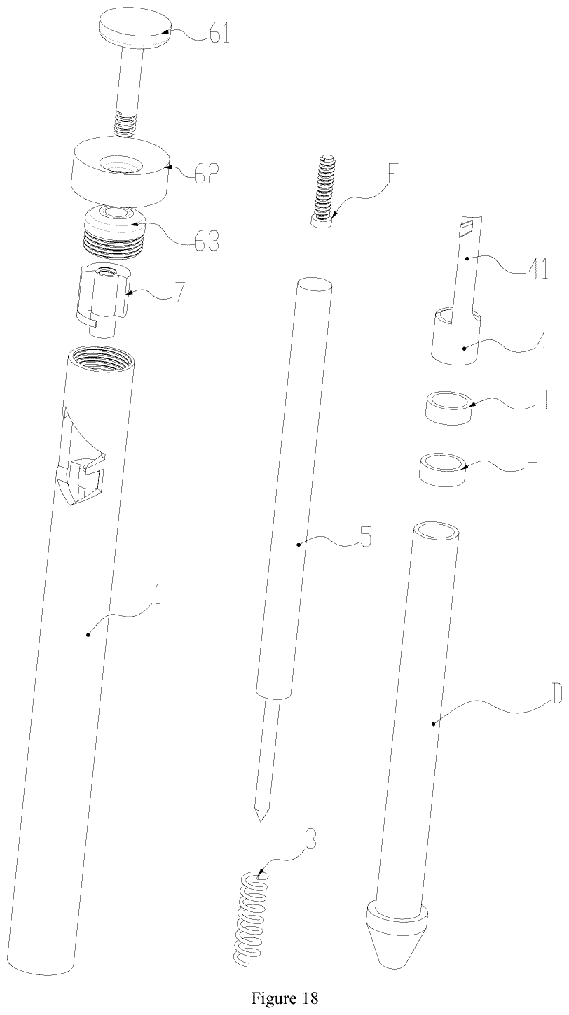

A mechanical pencil as shown in FIGS. 14-18, comprising an sleeve 1, a resetting part 3, a tool body and an adjusting module. The adjusting module comprises a control part 2 and an adjusting part 4.

A positioning slot 71 and a positioning portion 72 are provided on the sleeve 1. A displacement part 41 is provided on the adjusting part 4, and the displacement part 41 is movable in the positioning slot 71.

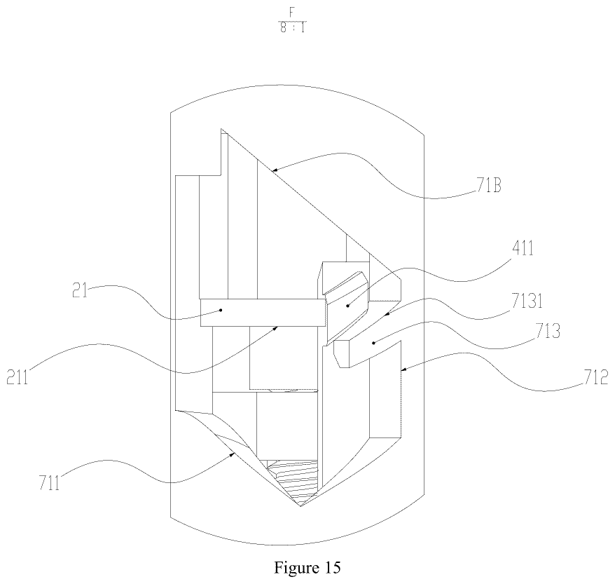

A control bar 21 is provided on the control part 2. A tail portion of the tool body 5 is rested on the positioning portion 72, a part of the tool body 5 is provided in the adjusting part 4, the resetting part 3 is completely provided in the adjusting part 4, a lead retraction switch wall 711, a long switch ramp 71B and a lead retraction boss 713 are provided in the positioning slot 71. A lead driving sliding wall 7131 is provided on the lead driving lug 713. And positions of A and B are in FIG. 15.

A bottom portion of the lead retraction switch wall 711 comprises the lead retracted position A, at this time, the tool body 5 is completely hidden in the adjusting part 4 and at this time the lead is retracted.

When the displacement part 41 is located on the lead driving sliding wall 7131, subjected to the influence of the lead driving sliding wall 7131 and the resetting part 3 the displacement part 41 will move along an inclination direction of the lead driving sliding wall 7131, before leaving the lead driving sliding wall 7131, the displacement part 41 is limited by the control bar 21, finally the displacement part 41 will remain on the lead driving sliding wall 7131 and a position where the displacement part 41 is comprises a lead driving position B. At this time the lead is driving out.

A method to realize pulling lead retraction with the control bar 21: a return assistance slope 213 is provided on the control bar 21, to retract the lead, move the displacement part 41 upwards to leave the lead retraction boss 713 via the long switch ramp 71B, and subsequently, free the displacement part 41 from the limitation of the control bar 21 via the resetting part 3 and the return assistance slope 213.

A solution for moving the displacement part 41 leftward or rightward in the positioning slot 71, a displacement clip 411 is provided on the displacement part 41. The displacement clip 411 replaces the displacement part 41 to contact directly the positioning slot 71. The displacement part 41 is capable of leftward or rightward deformation and bending, and is bendable so to move leftward or rightward in the positioning slot 71 without moving the adjusting part 4.

A solution for moving the displacement part 41 from the lead retracted position A to the lead driving position B in the positioning slot 71, an auxiliary lead driving slope B1 is provided at an end of the lead driving lug 713 close to the lead retracted position A and/or an end of the displacement part 41 close to the lead driving position B, the displacement part 41 is capable of deformation forward or backward and is bendable, when the displacement part 41 passes the lead driving lug 713, with the lead driving assistance slope B1 and the deformation and bending ability of the displacement part 41, the displacement part bypasses the lead driving lug 713 and reaches the lead driving position B.

To realize trigger lead retraction, a trigger assembly 6 is provided on the sleeve 1, by influencing movement of the control part 2 via the trigger assembly, the trigger method, trigger direction and trigger scope of the control part 2 can be changed. The trigger assembly 6 comprises a limiting part 61, a trigger ring 62 and a trigger cover 63. The limiting part 61 passes the trigger cover 63 and is connected with the control part 2, the control part 2 moves along with the limiting part 61. The trigger cover 63 and the sleeve 1 are interconnected. The trigger ring 62 is located in between the limiting part 61 and the trigger cover 63. At least one trigger assistance diagonal ring C is provided underneath the limiting part 61, above the trigger ring 62, underneath the trigger ring 62 and/or above the trigger cover 63.

To ensure the trigger is easier, an outer diameter of the trigger ring 63 is bigger than an outer diameter of the sleeve 1. Frictions on the surfaces of the control part and/or the trigger ring is the smaller the better.

To guarantee that the control part can function as a control part to a better extent, only vertical movement is allowed in between the control part 2 and the sleeve 1, leftward or rightward rotation is not allowed and a maximum downward movement threshold is preset.

To switch from the lead retraction state to the lead driving state: applying an external force, maintaining the sleeve 1 stable, moving the adjusting part 4, moving the displacement part 41 from the lead retracted position A to above the lead driving boss 713, releasing the external force, the displacement part 41 will fall back due to the influence of the resetting part 3 and remain at the lead driving position B after contacting the lead driving sliding wall 7131 and the control bar 21.

To prevent the adjusting part 4 from leaving the sleeve, the displacement boss 411 can be configured to be independent, after installing the adjusting part into the sleeve, installing the adjusting part 4; in this way the adjusting part 4 is not liable to depart from the sleeve.

To adapt to the tool bodies of different sizes: an adjusting hole E1 is provided at a portion where the tool body is connected, an adjustable base E is provided in the adjusting hole E1, the adjusting base E and the adjusting hole E1 are connected via threads or clearance fit; the portion where the tool body is connected comprises a connection portion between the sleeve 1, the adjusting part 4 or the positioning part 7; spatial relationships between the adjustable base E and the adjusting hole E1 can be adjusted by an external adjusting too so as to change an allowable length of the tool body 5 in the sleeve 1 or the adjusting part 4; a scale relevant to the product or common scales are provided on the external adjusting tool, the scale relevant to the product is specially designed for the tool body 5, a plurality of scale lines with common specifications and lengths adaptive to the tool body 5 are provided on the handle, with the scale lines of different dimensions, it is possible to rotate the tool body 5 to align with a lowermost portion of the sleeve 1 or the adjusting part 4, an internal length can be adjusted to be corresponding to an internal length corresponding to the designated specification, so that the user can adjust as required, without considering the lengths of different specifications.

The lead replacement portion D is provided underneath the adjusting part 4, two magnetic attractive articles H are provided in between the adjusting part 4 and the lead replacement portion D, with the magnetic attraction in between the two magnetically attractive articles the adjusting part 4 can engage with the lead replacement portion D and the adjusting part 4 is rotatable relative to the lead replacement portion D.

A method to install the mechanical pencil:
1. Installing the control part 2, the trigger cover 63, the trigger ring 62 and the limiting part 61 into the sleeve 1, the trigger cover 63 engages with the sleeve 1, passing the limiting part 61 through the trigger ring 62, the trigger cover 63 and the control part 2;
2. Installing the adjustable base E into the sleeve 1 with the external adjusting tool 5, and adjusting as necessary for the dimension of the tool body 5;
3. Installing the adjusting part 4, the tool body 5, the resetting part 3 and the lead displacement portion into the sleeve, the lead replacement portion and the adjusting part 4 engage with each other;
4. At this time, checking whether the displacement boss 411 is located in the positioning slot 71, if not, adjusting the position of the adjusting part to promise that the displacement boss 411 is located in the positioning slot 711.

In the present embodiment, the auxiliary resetting part is not included, therefore, the control part 2 can be reset under action of the gravity, before use, the entire mechanical pencil can be vertically disposed, propel the lead, so that the lead can be successfully driving; apparently, the auxiliary resetting part can be directly configured in between the control part 2 and the trigger cover 63 so as to enhance usage experience.

Specifically, with reference to FIG. 6, a way to propel the lead: using the lead driving solution two: maintaining the sleeve 1 stable, controlling the adjusting part 4 to move upwards, when the displacement part 41 passes the lead driving lug 713, with the deformation and bending ability of the lead driving auxiliary slope B1 and the displacement part 41, the lead driving lug 713 is bypassed, and the displacement part 41 reaches the lead driving position B;

In the meanwhile, there are the following two ways to retract the lead:
1. Trigger lead retraction solution one: placing the product according to the present invention on a desk, in a bag, box or pocket, the trigger ring 62 will be touched by articles therein, the force generated due to touch will be transmitted to the limiting part 61, the limiting part 61 will move upwards, and drive the control part 2 to move upwards, when the control part 2 moves upwards, the displacement boss 411 will release limitation on the control part 2, and slide to the lead retracted position A along the lead driving sliding wall 7131 and at this time, the tool body will be completely hidden in the lead replacement portion D;
2. Pulling lead retraction solution two: controlling the adjusting part 4 to move upwards with an external force, reaching above the limiting lug 211 via the long switch ramp 71B, releasing the external force and having the displacement part 41 to leave limitation of the control part 2 via the return assistance slope 213 and the resetting part 3 on the control bar 21, and returns to the lead retracted position A.

### Embodiment 4

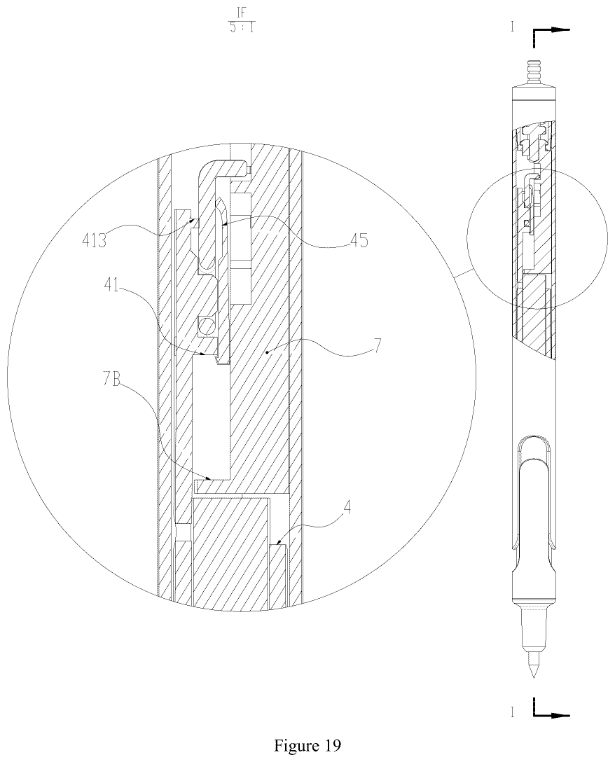

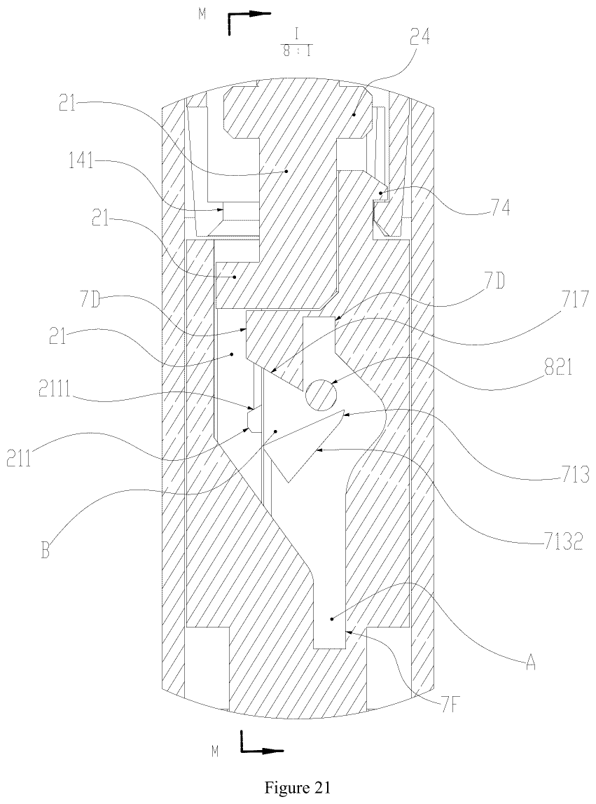

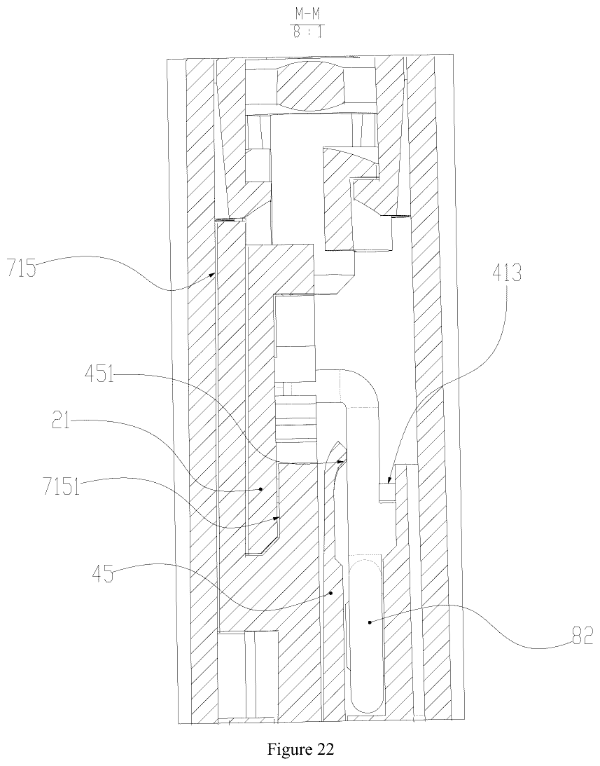

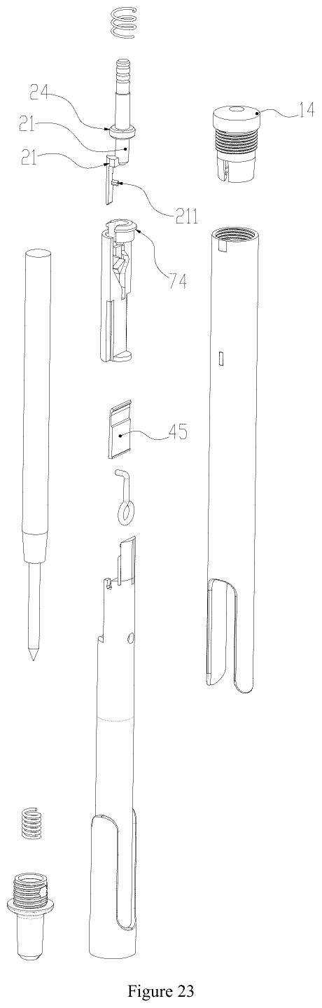

A mechanical pencil as shown in FIGS. 19-23, wherein parts of the mechanical pencil are similar to those in the embodiments 1-3, by configuring displacement of the adjusting part 4 in the sleeve 1, a spatial relationship of the tool body 5 is controlled, the tool body 5 has two states, namely, lead retracted or lead driving, the adjusting part 4 realizes relative stability of the two spatial relationship via the positioning slot 71 on the positioning part 7 or the sleeve 1, the resetting part 3 and the control part 2; the resetting part 3 provides a continuous force transmitted by the tool body 5 to the adjusting part 4 so that a state of the displacement part 41 on the adjusting part 4 at the lead retracted position is relatively stable; the displacement part 41 when moving to the lead driving position in the positioning slot 71, with the control part 2, a state of the displacement part at the lead driving position is maintained relatively stable;

There are three ways to switch from the lead driving state to the lead retraction state: first of all, moving to control lead retraction: controlling the control part 2 to move upwards or downwards via an external force, having the displacement part 4 to leave limitation of the control part 2, the displacement part 41 will move downwards when subjected to the influence of the resetting part 3 so as to retract the lead; a second solution is to pull to retract the lead: maintaining the sleeve 1 stable, controlling the adjusting part 4 to move upwards, having the displacement part to depart from limitation of the control part 2 via the long swtich wall 71B, the control switch wall on the control part 2 and the resetting part 3 and return to the lead retracted position; a third solution is a second pulling lead retraction solution: maintaining the sleeve 1 stable, controlling the adjusting part 4 to move upwards with an external force, having the displacement part 41 to free from limitation of the control part 2 and return to the lead retracted position.

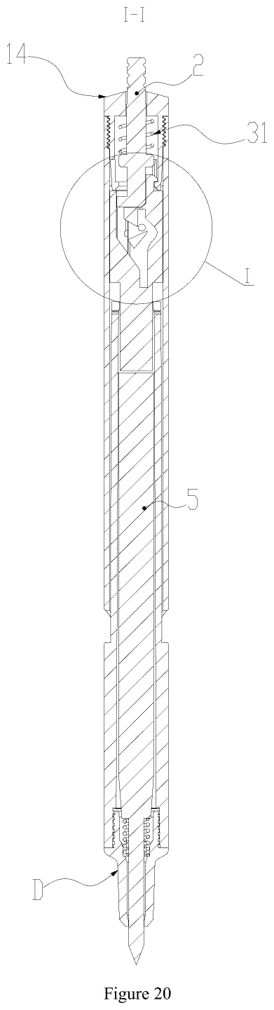

With reference to FIGS. 20-23, similar to the embodiment 1, a solution for moving the displacement part 41 leftwards or rightwards in the positioning slot 71, a rotation lug 412 is provided on the displacement part 41, a rotation part 82 is provided on the rotation lug 412, an end of the rotation part 82 is sleeved on the rotation lug 412, the revolution part 82 is rotatable relative to the rotation lug 412, a displacement portion 821 is provided at another end of the rotation part 82, and the displacement portion 821, instead of the displacement part 41, contacts directly the positioning slot 71. The displacement part 41 is not to rotate leftwards or rightwards, and when it is necessary to move leftwards or rightwards, rotate the revolution part 82 relative to the rotation lug 412.

A solution to moving the displacement part 41 in the positioning slot 71 from the lead retracted position A to the lead driving position B, wherein a lead driving guiding ramp 7132 is provided on the lead driving lug 713 close to a side of the lead retracted position A. A lead driving channel B2 is provided in between the long switch ramp 71B and the lead driving lug 713. The displacement part 41 when moving upwards from the lead retracted position A, subjected to the influence of the lead driving guiding ramp 7132, enters the lead driving channel B2, and reaches above the lead driving position B via the long switch ramp 71B, at this time, releasing the external force, the displacement part 41 will fall back to the lead driving position B.

To avoid erroneous operations, a lead retraction limiting ramp 716 and a lead retraction assistance ramp 717 are provided in the positioning slot 71. The lead retraction limiting ramp 716 is configured primarily to limit the displacement part 41, prevent the displacement part 41 to move upwards overdue, and consequently the displacement part 41 can no longer remain at the lead driving position B. The lead retraction assistance ramp 717 is configured when the long switch ramp 71B is stopped by the lead retraction limiting ramp 716, becomes shorter, and can no longer help the displacement part 41 to pull to retract the lead, therefore, the lead retraction assistance ramp 717 can replace the long switch ramp 71B to help the displacement part 41 to retract the lead by pulling.

To ensure that the control part 2 can control the lead driving and retraction stably, only vertical movement is permitted in between the control part 2 and the sleeve 1, lateral rotation is not allowed, and a downward movement limitation is configured.

To avoid the unnecessary interference due to fabrication errors and avoid unnecessary stoppage, an auxiliary passage slope 141 is provided in the lead retraction channel 214 close to a side of the lead driving position B.

To promise return stability, a fall-proof boss 719 is provided in the positioning slot 71, and a return passage 71A is provided in between the limiting lug 211 and the fall-proof boss 719 or an inner surface of the sleeve 1 and the limiting lug 211.

To ensure that the control bar can have a better effect, a control slot 715 for allowing the control bar to move up and down is provided on the positioning part 7. The control bar 21 passes the control slot 715 to limit the displacement portion 721 of the revolution part 82 from leaving the lead driving sliding wall 7131. Preferably, the control slot 715 and the control bar 21 can be extended to the same level as the lead retracted position A and at this time, even when the control bar 21 moves up due to influence of the trigger assembly 6, the displacement portion 821 enters the lead retraction switch wall 711 at the moment of trigger when the control bar 21 is released, a displacement notch for the control bar 21 will not appear in between the control bar 21 and the lead retraction switch wall 711, the entire system is working more stably, and the displacement portion 821 will not fall into the displacement notch for the control bar 21. A sliding assistance slope 718 for allowing the displacement part 41 to slide is provided in the positioning slot 71, given that the displacement part 41 may be jammed due to a relationship with the control slot 715, by providing the sliding assistance slope 718 the jamming during falling back can be addressed. The control slot 715 can also serve as an installation channel for the displacement portion 821 to ease installation.

To switch from the lead retraction state to the lead driving state: applying an external force, maintaining the sleeve 1 unmoved, moving the adjusting part 4, moving the displacement part 41 from the lead retracted position A to above the lead driving lug 713, releasing the external force, the displacement part 41 falls back due to the influence of the resetting part 3, and stops at the lead driving position B upon contact with the lead driving sliding wall 7131 and the control bar 21.

To further improve the tolerance: a lower end point of the control switch wall 212 is higher than an upper end point of the lead retraction assistance ramp 717 and a better effect can be realized.

To ease installation and repairing, a cover 14 is provided on the sleeve 1, and the cover 14 engages with the sleeve 1.

To ease installation of the adjusting assembly into the sleeve, the positioning part 7 needs to engage with the cover 14, in the present embodiment, the positioning part 7 engages with the cover 14 by clearance fit, an engagement portion 74 is provided on the positioning part 7; a cover buckle 141 is provided on the cover 14; the cover buckle 141 is configured to be in sections, and curved inwards, so as to make it convenient to install the engagement portion 74 into the cover 14; after installing the engagement portion 74 into the cover 14, it is not easy to pull it out. To make it convenient to fix the auxiliary resetting part, a circular resetting lug 24 is provided on the control part 2.

To reduce the negative influence of the gravity on the revolution part to a maximum extent, a revolution stabilizing boss 45 is provided on the adjusting part 4, a stabilizing abutment boss 451 is provided on the revolution stabilizing boss 45.

To make it convenient to make the mechanical pencil, for example, quick demolding, the revolution stabilizing boss 45 can be separated to be an individual accessary, and fixed onto the adjusting part 4, the sleeve 1 or the positioning part 7, and the installation method can be clearance fit, glue connection, magnetic absorption, screw connection or fixation with a third party tool.

To avoid unnecessary impact of installation on the revolution part 82, an installation cushioning slot 7D is provided in the positioning slot 71; to protect the revolution part 82 and the positioning slot to a better extent, a positioning limiting lug 7B is provided on the positioning part 7, and a lead retraction tolerance slot 7F is provided in the positioning slot 71; by limitation in between the positioning limiting lug 7B and the displacement part 41, limitation in between the revolution part 82 and the positioning slot becomes unnecessary, consequently, unnecessary obstruction between the revolution part 82 and the positioning slot during lead retracted state is avoided, and with the lead retraction tolerance slot 7F a bigger tolerance is allowed, so as to promise that at the lead retracted state, impact will not occur on the revolution part 82 and the positioning slot.

For the installation method, please refer to the embodiment 2.

For the lead driving method the pulling lead driving solution three is used: controlling the adjusting part 4 to move upwards, when the displacement part 41 moves from the lead retracted position A, subjected to the influence of the lead driving guiding ramp 7132, the displacement part 41 enters the lead driving channel B2, subsequently, reaches above the lead driving position B via the long switch ramp 71B, and at this time, releasing the external force, the displacement part will fall back to the lead driving position B.

In the meanwhile there are two solutions for retracting the lead:
1. Movement lead retraction: moving the control part 2 upwards via an external force, releasing the displacement part 41 from limitation of the control part 2, the displacement part 41 will move subjected to the influence of the resetting part 3 and the lead is retracted;
2. Pulling lead retraction solution one: moving the adjusting part upwards with an external force, bypassing the displacement part 41 from the limitation of the limiting lug 211 via the lead retraction assistance ramp 717 in the positioning slot 71, and the displacement part 41 will return to the lead retracted position A due to the influence of the resetting part 3.

### Embodiment 5

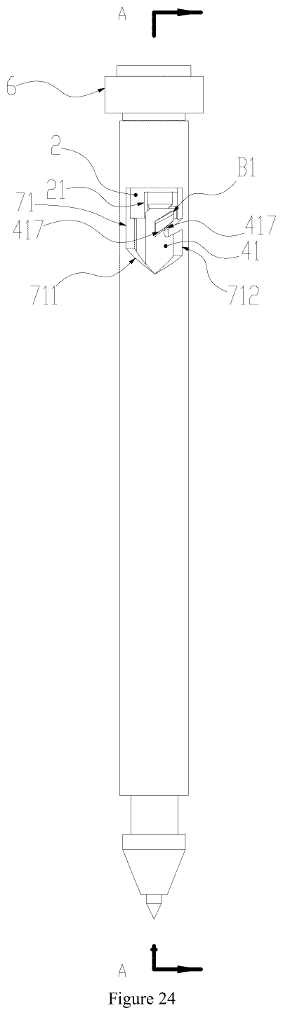

Two kinds of mechanical pencils as shown in FIGS. 24-25 and 26-27, comprising an sleeve 1, a resetting part 3, a tool body 5 and an adjusting module. The adjusting module comprises a control part 2, an adjusting part 4 and a trigger assembly 6. A control bar 21 is provided on the control part 2.

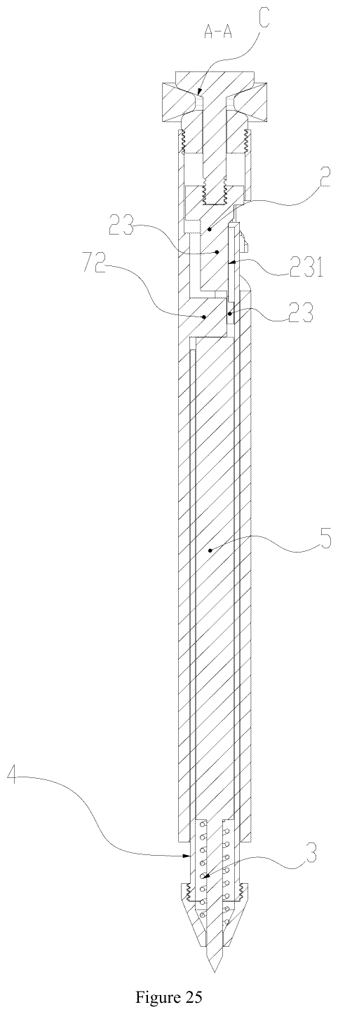

A positioning slot 71 is opened in the sleeve 1. A lead retraction switch wall 711, a lead retraction limiting wall 712 and a lead driving lug 713 are provided in the positioning slot 71. A lead driving sliding wall 7131 is provided on the lead driving lug 713. Wherein in an embodiment as shown in FIGS. 24-25, a thrust assistance slope 417 is provided on the lead driving lug 713 and/or the displacement part 41.

A tail end portion of the tool body 5 is abutted against the positioning portion 72, a part of the tool body is provided in the adjusting part 4, and the resetting part 3 is entirely provided in the adjusting part 4.

A displacement part 41 is provided on the adjusting part 4 and the displacement part 41 is movably provided in the positioning slot 71.

The tool body 5 and the resetting part 3 are provided in the adjusting part 4, the resetting part 3 is specifically provided in between the tool body 5 and the adjusting part 4. The tail end portion of the tool body 5 is abutted against a lower end portion of the displacement portion 72.

The control part 2 and the adjusting part 4 are slidably sleeved inside the sleeve 1:

A lead retracted position A is formed at an included angle in between the lead retraction switch wall 711 and the lead retraction limiting wall 712. The lead driving sliding wall 7131 comprises a lead driving position B.

The trigger assembly 6 is configured to collect trigger force, transmitted the same to the control part 2 and control movement of the control part 21/

The displacement part 41 is located on the lead retracted position A, at this time, the tool body 5 is maintained to be hidden inside the adjusting part, and at this time the lead is retracted.

When the displacement part 41 is located on the lead driving sliding wall 7131, subjected to the influence of the lead driving sliding wall 7131 and the resetting part 3, the displacement part 41 will move along an inclination direction of the lead driving sliding wall 7131, before departing from the lead driving sliding wall 7131, the displacement part 41 is limited by the control bar 21 on the displacement part 41 and/or the adjusting part 4 and cannot leave the lead driving sliding wall 7131 completely, at this time, the lead driving sliding wall 7131 dictates a height and spatial relationship of the displacement part 41. Finally the displacement part 41 will remain on the lead driving sliding wall 7131 and the position where the displacement part 41 is comprises the lead driving position B. At this time, a writing portion of the tool body 5 will be exposed out of the adjusting part 4 and the lead is driving.

The control bar 21 can move up and down or forward or backward relative to the positioning slot 71 and is not allowed to move leftwards or rightwards.

In the embodiment shown in FIGS. 24-25, a displacement clip 411 or a sliding ball slot is provided on the displacement part 41, and the displacement part 41 is not capable of deformation. A shape of the positioning slot 71 at the lead retracted position A can be adjusted adaptively according to a shape of the displacement clip 411, the at least one sliding ball 8 and/or a shape of the displacement part 41 slidable in the positioning slot 71.

A lead driving assistance slope B1 is provided at an end portion of the lead driving lug 713 close to the lead retracted position A and/or an end portion of the displacement part 41 close to the lead driving position B, and the displacement part 41 is capable of deformation forward or backward, when the displacement part 41 passes the lead driving lug 713, with the lead driving assistance slope B1 and the deformation and bending ability of the displacement part 41, the displacement part 41 goes beyond the lead driving lug 713, and reaches the lead driving position B. With this solution, it is necessary to ensure that after the displacement part 41 reaches the lead driving position B, the displacement part 41 cannot return to the lead retracted position A via the deformation and bending abilities thereof, for example: providing inverted hooks on the lead driving lug 713, increasing coarse grains, increasing frictions and/or increasing contact surfaces.

The trigger assembly 6 comprises a limiting part 61, a trigger ring 62 and a trigger cover 63/the limiting part 61 passes the trigger cover 63 and the control part 2 and are interconnected, and the control part 2 moves along with the limiting part 61. The trigger cover 63 and the sleeve 1 are interconnected, and the trigger cover 63 does not make any movement relative to the sleeve 1. The trigger ring 62 is provided in between the limiting part 61 and the trigger cover 63. At least one trigger assistance diagonal ring C is provided underneath the limiting part 61, above the trigger ring 62, underneath the trigger ring 62 and/or above the trigger cover 63. When being subjected to an external force, with the at least one trigger assistance diagonal ring C, the control part 2 can move up relative to the positioning slot 71, so as to move the control bar 21 and have the displacement part 21 slide from the lead driving position B to the lead retracted position A.

The embodiment shown in FIGS. 24-25 can also realize thrust lead retraction: maintaining the sleeve 1 unmoved, pulling the adjusting part 4 to move up with an external force, with the thrust assistance slope 417, the displacement part 41 can be free from the limitation of the lead driving lug 731 and return to the lead retracted position A.

For driving the lead the pulling lead driving solution two is adopted: maintaining the sleeve 1 unmoved, controlling the adjusting part 4 to move up with an external force, when the displacement part 41 passes the lead driving lug 713 with the lead driving assistance slope B1 and the deformation and bending ability of the displacement part 41, the displacement part 41 will leave the lead driving lug 713 and reach the lead driving position B;

In the meanwhile, there are the following two ways to retract the lead:
1. Trigger lead retraction solution one: placing the product of the present invention directly on a desk, in a bag, pocket or box, the trigger ring 62 will be subjected to touch of articles therein, the force generated due to touch will be transmitted to the limiting part 61, the limiting part 61 will move up, and drive the control part 2 to move up, when the control part 2 moves up, the displacement boss 411 will lose limitation on the control part 2, and slide along the lead driving sliding wall 7131 to the lead retracting position A, and at this time, the tool body will be completely hidden in the lead replacement portion D;
2. Thrust lead retraction solution two: maintaining the sleeve 1 unmoved, pulling the adjusting part 4 to move down with an external force, with the thrust assistance slope 417, the displacement part 41 will be free from the limitation of the lead driving lug 713 and return to the lead retracted position A.

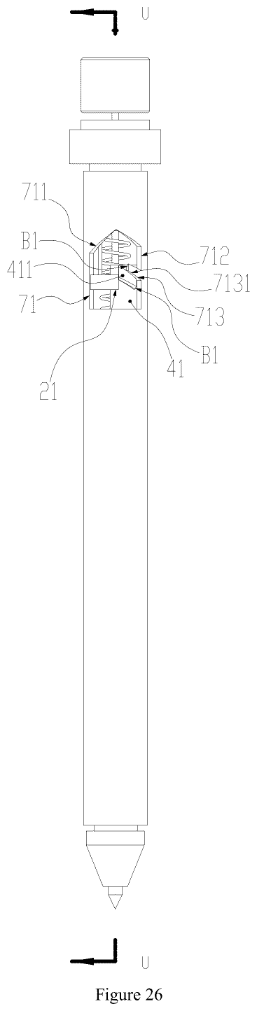

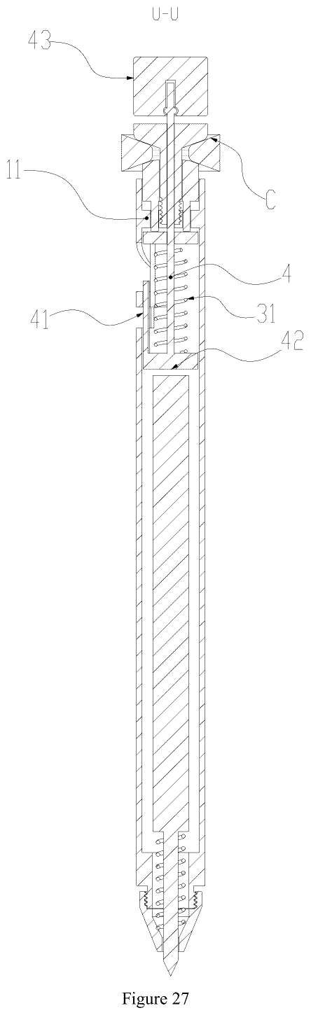

In the embodiment as shown in FIGS. 26-27, a displacement clip 411 is provided on the displacement part 41, and the displacement part 41 is not capable of deformation leftward or rightward, when it is necessary to move leftward or rightward, moving the entire adjusting part 4 leftward or rightward.

A shape of the lead retracted position A in the positioning slot 71 can be adaptively adjusted according to a shape of the displacement clip 411, the at least one sliding ball 8 and/or the displacement part 41 in the positioning part 41/

An auxiliary resetting part 31 is provided in between the control part 2 and the trigger assembly 6.

In the embodiment as shown in FIGS. 26-27, a connection body 11 is provided on the sleeve 1. The limiting part 61 passes the trigger cover 63 and is connected with the connection body 11, the trigger cover 63 passes the connection body 11 and is connected with or abutted against the control part 2. The trigger cover 63 moves downwards and the control part 2 will be pressed to move downwards. The trigger ring 62 is located in between the limiting part 61 and the trigger cover 63. At least one trigger assistance diagonal ring C is provided underneath the trigger cover 63, above the trigger ring 62, underneath the trigger ring 62 and/or above the trigger cover 63. When the trigger ring 62 is pressed by an external force, with the trigger assistance diagonal ring C the control part 2 can be moved down relative to the positioning slot 71, so that the control bar 21 can move down and the displacement part 21 can slide from the lead driving position B to the lead retracted position A.

A trigger solution one: controlling the control part 2 to move upwards with the trigger assembly 6 indirectly. A trigger solution two, controlling the control part 2 to move downwards via the trigger assembly 6. The trigger method can be selected according to a direction that the control part shall be controlled to move towards.

The lead driving method can be done with the lead retraction solution one: placing the product of the present invention directly on a desk, in a bag, box or pocket, the trigger ring 62 will be touched by articles therein, the force generated due to touch will be transmitted to the limiting part 61, the limiting part 61 will move upwards, and drive the control part 2 to move upwards, when the control part 2 moves upwards, the displacement boss 411 will lose limitation on the control part 2, and slide along the lead driving sliding wall 7131 towards the lead retracted position A, and at this time, the tool body will be completely hidden in the pencil replacement portion D.

### Embodiment 6

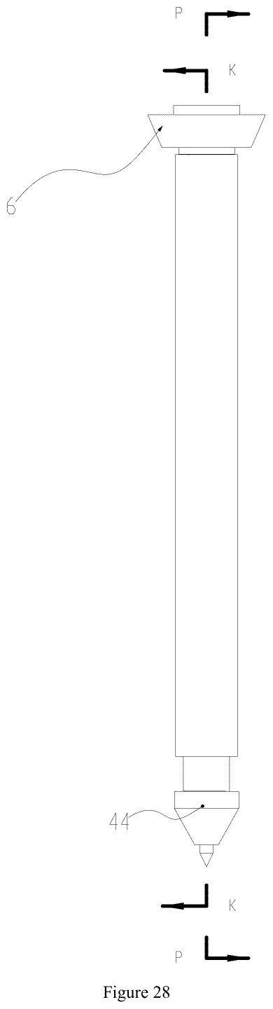

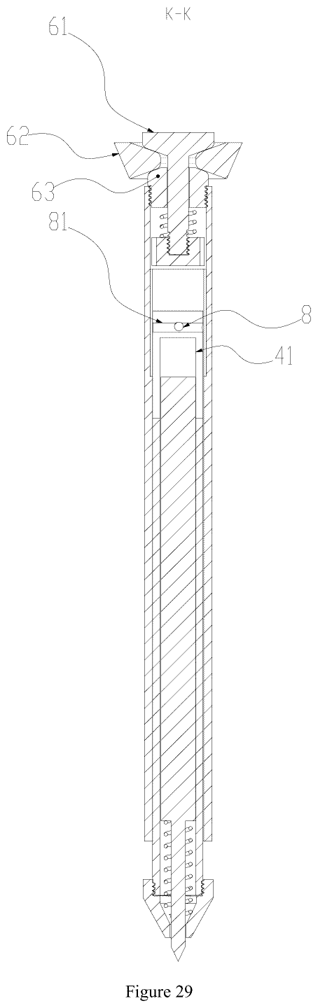

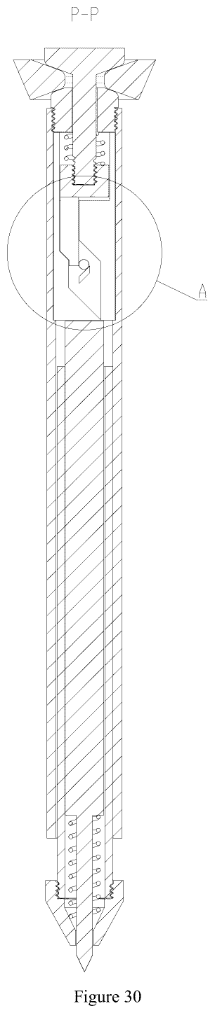

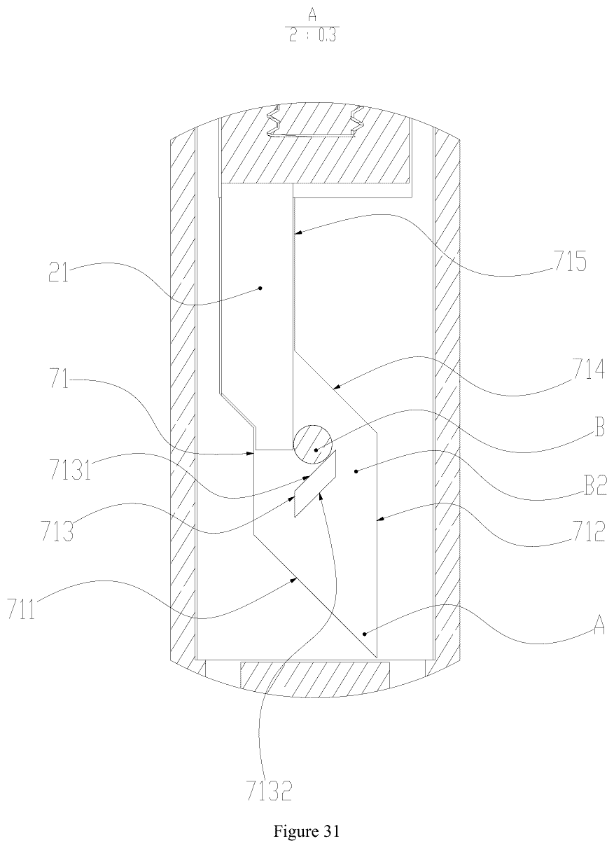

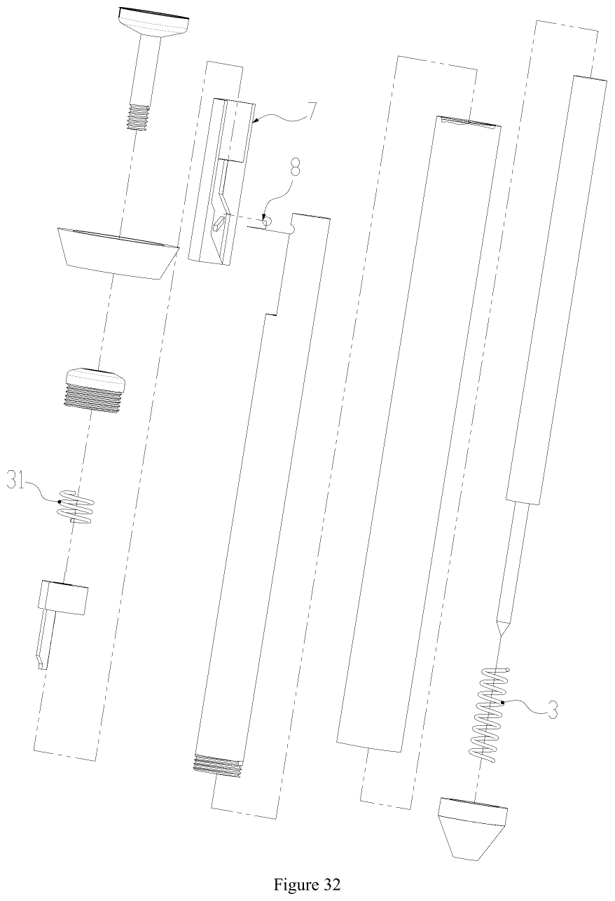

A mechanical pencil as shown in FIGS. 28-32, comprises an sleeve 1, a resetting part 3, a tool body 5 and an adjusting assembly. The adjusting assembly comprises a control part 2, an adjusting part 4, a trigger assembly 6 and a positioning part 7.

A control bar 21 is provided on the control part 2. A tail end portion of the tool body 5 is abutted against the positioning part 7, a part of the tool body 5 is provided in the adjusting part 4, and the resetting part 3 is completely provided in the adjusting part 4. The positioning part 7 is installed in the sleeve 1, and cannot make large-scale vertical movement and preferably no vertical movement can be done. A positioning slot 71 is provided in the positioning part 7. A lead retraction switch wall 711, a lead retraction limiting wall 712 and a lead driving lug 713 are provided in the positioning slot 71. A lead driving sliding wall 7131 is provided on the lead driving lug 713.

A displacement part 41 is provided on the adjusting part 4 and the displacement part 41 is movably provided in the positioning slot 71.

The tool body 5 and the resetting part 3 are provided in the adjusting part 4, and the resetting part 3 is specifically in between the tool body 5 and the adjusting part 4. The tail end portion of the tool body 5 is abutted against a lower end portion of the positioning part 7.

The control part 2 and the adjusting part 4 are slidably sleeved in the sleeve 1:

A lead retracted position A is formed at an included angle between the lead retraction switch wall 711 and a lead retraction limiting wall 713.

The displacement part 41 is located in the lead retracted position A, at this time, the tool body 5 is completely hidden in the adjusting part 4 and the lead is retracted.

When the displacement part 41 is located on the lead driving sliding wall 7131, subjected to the influence of the lead driving sliding wall 7131 and the resetting part 3 the displacement part 41 will move along an inclination direction of the lead driving sliding wall 7131, before departing from the lead driving sliding wall 7131 completely, due to limitation of the control bar 21 on the positioning part 7, the displacement part 41 and/or the adjusting part 4, the displacement part 41 cannot depart from the lead driving sliding wall 7131 completely; at this time, the lead driving sliding wall 7131 dictates a height and spatial relationship of the displacement part 41. Finally the displacement part 41 will remain on the lead driving sliding wall 7131 and the position where the displacement part 41 is at this time is the lead driving position B. at this time, the writing portion of the tool body 5 will be exposed out of the adjusting part 4, and the lead is driving.

The trigger assembly 6 is configured to collect external trigger force, transmit to the control part 2, and control movement of the control bar 21, when the control bar 21 is released from contact with the displacement part 41, the displacement part 41 will move from the lead driving position B to the lead retracted position A.

The control bar 21 can make up and down, forward and backward movement relative to the positioning part 7 and cannot make leftward or rightward movement.

A movable slot 81 is provided on the displacement part 41, and at least one sliding ball 8 is provided in between the movable slot 81 and the positioning slot 71. The at least one sliding ball 8 replaces the displacement part 41 to contact directly the positioning slot 71. With this solution, the adjusting part is not to be rotated or translated, is more stable, the manufacturing thereof is easier, installation thereof is easier and usage is smooth. The movable slot 81 comprises a straight movable slot, an arc-shaped movable slot and a ring movable slot. A movement trace of the straight movable slot is a straight line, and is suitable for use in planar positioning slots, a movement trace of the arc-shaped movable slot is a curved line, and is suitable for use in arc-shaped positioning slot. A movement trace of the ring movable slot comprises a ring, and is suitable for use in ring positioning slots.

When the control bar 21 is to limit the displacement clip 411, the at least one sliding ball or a portion of the displacement part 41 in the positioning slot 71, a control slot 715 is provided in the positioning slot 71. The control bar 21 passes the control slot 715 and limits the displacement clip 411, the at least one sliding ball 8 or the portion of the displacement part 41 in the positioning slot 71 from leaving the lead driving sliding wall 7131.

A lead driving guiding ramp 7132 is provided at a side of the lead driving lug 713 close to the lead retracted position A. A lead driving switch wall 714 is provided in the positioning slot 71. A lead driving channel B2 is provided in between the lead driving switch wall 714 and the lead driving lug 713. The displacement part 41 when moves upwards from the lead retracted position A, due to the influence of the lead driving guiding ramp 7132, the displacement part 41 will enter the lead driving channel B2 and subsequently reaches above the lead driving position B via the lead driving switch wall 714 and at this time, releasing the external force, the displacement part 41 will fall back to the lead retracted position B.

An auxiliary resetting part 31 is provided in between the control part 2 and the trigger assembly 6.

The trigger assembly 6 comprises a limiting part 61, a limiting ring 62 and a trigger cover 63. The limiting part 61 passes the trigger cover 63 and is connected with the control part 2, and the control part 2 moves along with the limiting part 61. The trigger cover 63 is connected with the sleeve 1, and the trigger cover 63 does not make any movement relative to the sleeve 1. The trigger ring 62 is provided in between the limiting part 61 and the trigger cover 63. At least on trigger assistance diagonal ring C is provided underneath the limiting part 61, above the trigger ring 62, underneath the trigger ring 62 and/or above the trigger cover 63. The trigger ring 62 when being pressed by an external force will have the control part 2 to move upwards relative to the positioning slot 71 via the trigger assistance diagonal ring C, so that the control bar 21 moves up, and the displacement part 21 will slide from the lead driving position B to the lead retracted position A.

To make it convenient for the at least one sliding ball 8 to slide into the movable slot, a sliding ball installation slot is provided in the positioning slot 71, a depth of the sliding ball installation slot is deeper than other portions of the positioning slot 71, in the meanwhile, an installation slope is provided in between the sliding ball installation slot and the other portions of the positioning slot 71, the installation slope is configured to cushion the installation of the at least one sliding ball, and make it convenient to slide the at least one sliding ball 8 from the sliding ball installation slot into the positioning slot 71.

The installation method is to assemble the positioning part 7, the at least one sliding ball 8 and the adjusting part to be the adjusting assembly, insert the positioning part 7 into the adjusting part 4, installing the at least one sliding ball 8 through the sliding ball installation slot in between the positioning slot 71 and the movable slot 81; at this time, the adjusting assembly is completed and install general parts subsequently.

For driving the lead the trigger lead retraction solution one is used: placing the product according to the present invention on a desk, in a bag, box or pocket, the trigger ring 62 will be touched by other articles therein, the force generated due to touch will be transmitted to the limiting part 61, the limiting part 61 will move upwards, and drive the control part 2 to move upwards, when the control part 2 moves upward, the at least one sliding ball 8 loses limitation on the control part 2, and will slide along the lead driving sliding wall 7131 to the lead retracted position A and at this time, the tool body will be hidden in the lead replacement portion D.

### Embodiment 7

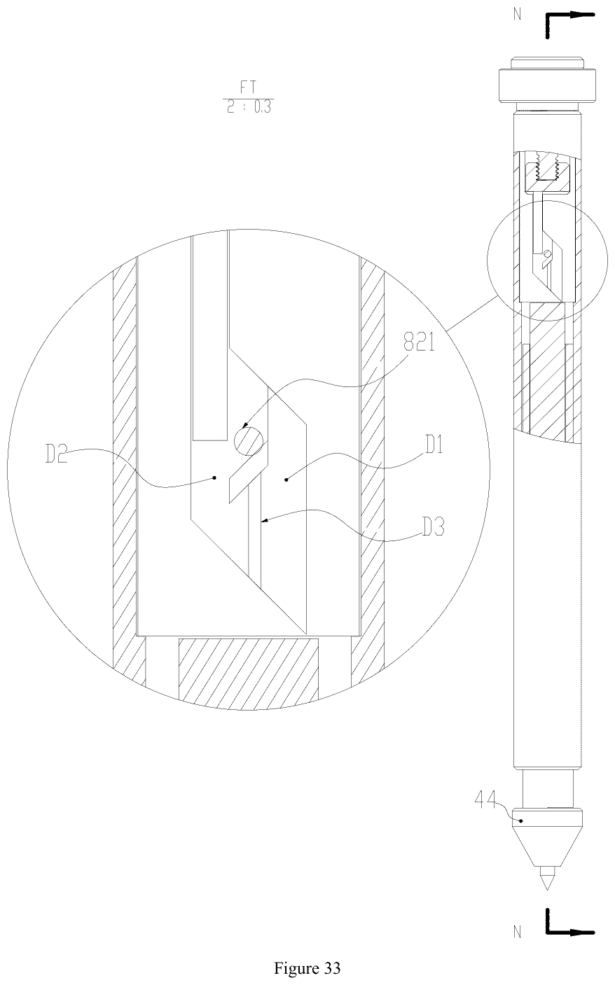

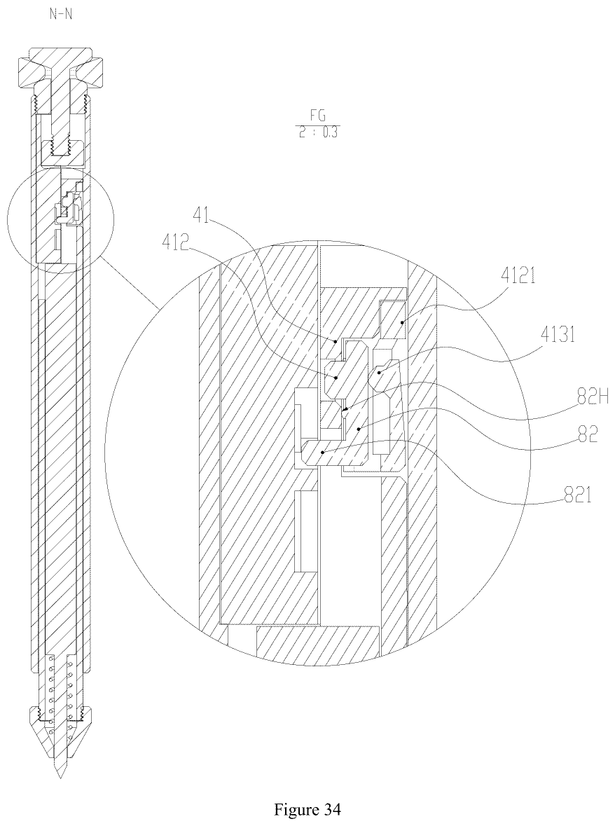

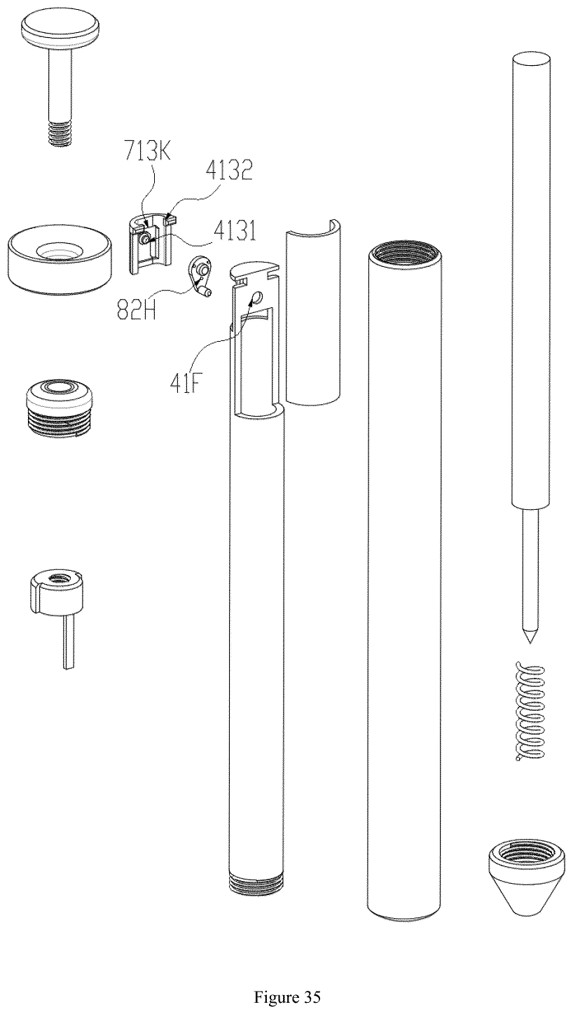

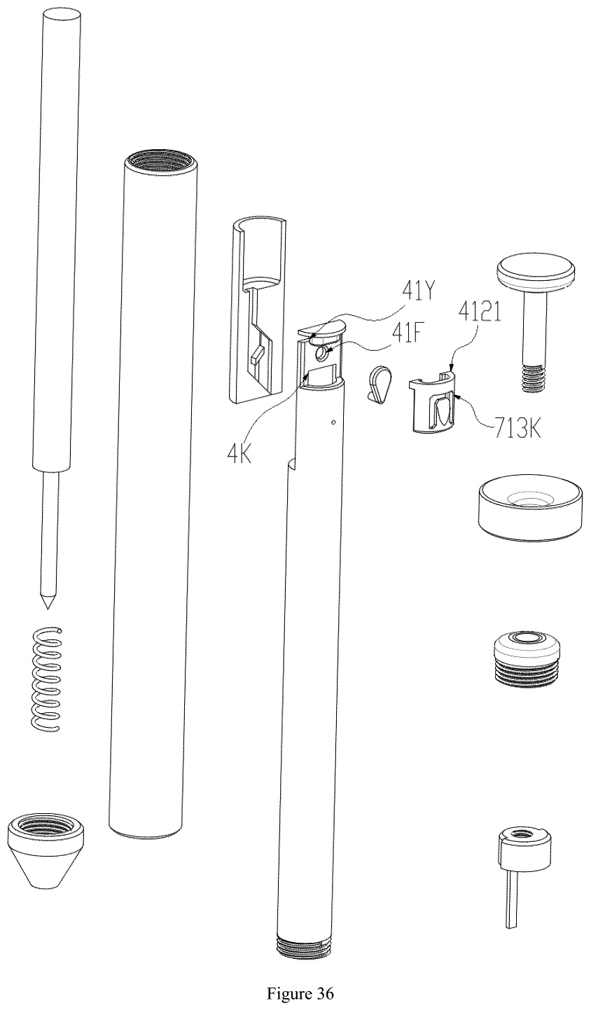

A mechanical pencil as shown in FIGS. 33-36, differences between the embodiment 7 and the embodiment 6 are that:

A rotation through-hole 41F and a rotation fastener 4121 are provided on the displacement part 41, a revolution part 82 is provided in the rotation through-hole 41F, a rotation lug 412, a displacement portion 821 and three rotation contact boss 82H are provided on the revolution part 82, after installing the rotation lug 412 into the rotation through-hole 41F, the revolution part 82 can rotate relative to the rotation through-hole 41F, the displacement portion 821 is provided at another end of the revolution part 82, and the displacement portion 821 replaces the displacement part 41 to contact directly the positioning slot 71; the rotation fastener 4121 comprises a clamping portion 4131, a deformation groove 713K and fitting portions 4132. The rotation fastener 4121 is installed inside the displacement part 41 via the fitting portions 4132, and corresponding clamping grooves 41Y are provided in the displacement part 41, after clamping the fitting portions 4132 into the clamping grooves 41Y, with the clamping portion 4131 and the deformation groove 713K, a continuous clamping force is exerted on the revolution part 82 so that the leftward and rightward rotation of the revolution part 82 is damped, and interference of the gravity is overcome.

With the rotation contact boss 82H, friction between the revolution part 82 and the displacement part 41 can be effectively reduced, so that on the basis of overcoming the gravity interference, a flexible adjustability is provided and actual operation experience can be improved.

Space is reserved behind the clamping portion 4131 for allowing the clamping portion 4131 to deform backwards.

In the present embodiment, the technical solution of placing the rotation lug on the revolution is used, and the rotation lug is higher than the displacement portion 821, the internal space is fully used, so that the entire length is reduced, appearance design freedom is bigger and leads of more specifications can be used. As a main body of the displacement part 41 is at an upper end portion close to the intermediate portion, a rotation opening 4K is provided in between the displacement part 41 and the adjusting part 4, and the displacement portion 821 enters the positioning slot 71 to move via the rotation opening 4K.

A lead driving guiding ramp 7132 is provided at a side of the lead driving lug 713 close to the lead retracted position A. A lead driving switch wall 714 is provided in the positioning slot 71. A lead driving channel B2 is provided in between the lead driving switch wall 714 and the lead driving lug 713. When the displacement part 41 moves upwards from the lead retracted position A, subjected to the influence of the lead driving guiding ramp 7132, the displacement part enters the lead driving channel B2, reaches above the lead driving position B via the lead driving switch wall 714, and at this time, releasing the external force, the displacement part 41 will fall back to the lead driving position B.

The positioning slot 71 is designed to have a plurality of dislocated layers. A flat slide D3 is provided for switching from a bottom layer D2 to a higher layer D1 in the plurality of dislocated layers. For example, the higher layer is formed at the lead retracted position A, the bottom layer is formed at the lead driving position B, and is lower than the lead retracted position A, in this way, the displacement part 41 slides from the lead retracted position A to the lead driving position B and is not liable to return to the lead retracted position A, and a travel trajectory similar to a one-way valve is formed. With the flat slide the displacement part 41 can return from an end point of the bottom layer to a starting point of the higher layer. Differences of the installation methods are that, an end of the revolution part is sleeved on the rotation lug on the adjusting part, inserting the positioning part into the adjusting part, installing the displacement portion at another end into the positioning slot; and at this time, the adjusting assembly is complete. The ways to retract or propel the lead are similar to those in the embodiment 6 and only specific structures of the displacement part 41 are replaced.

### Embodiment 8

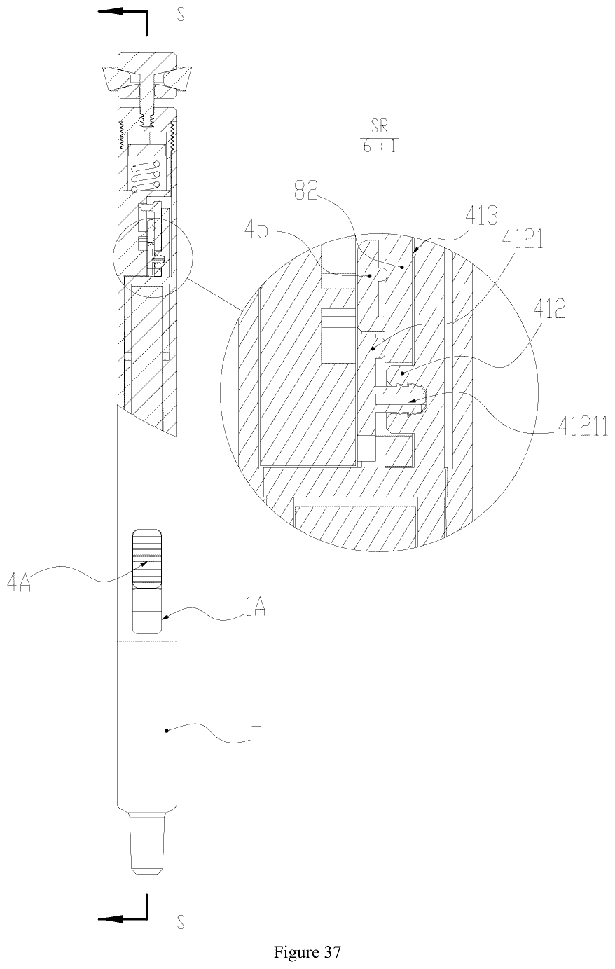

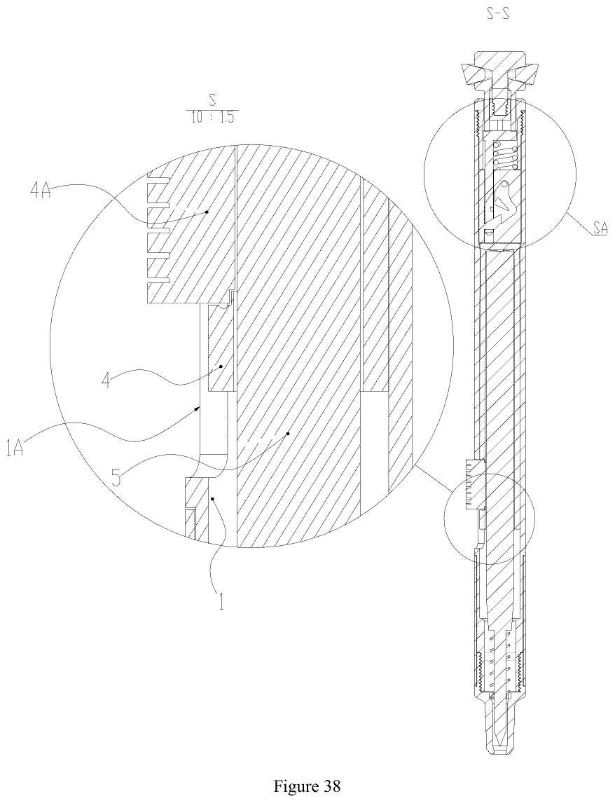

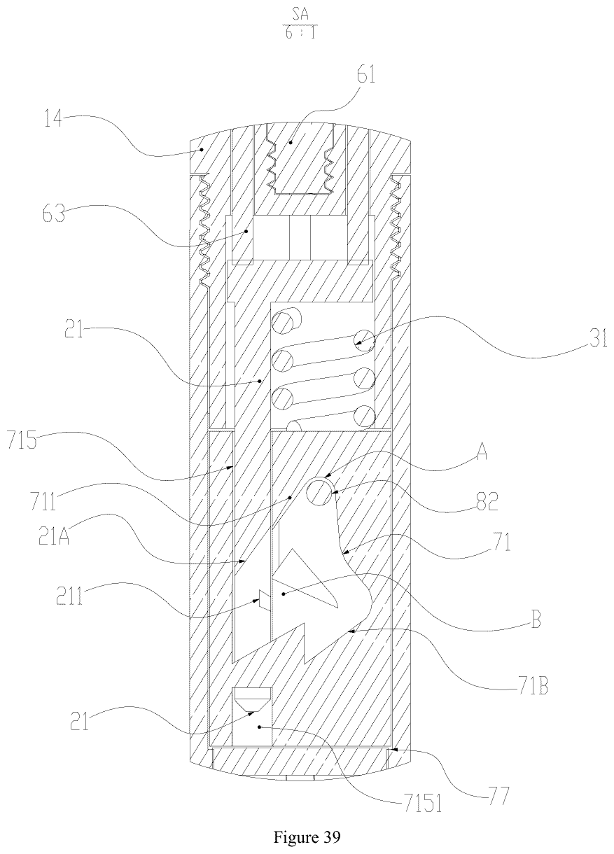

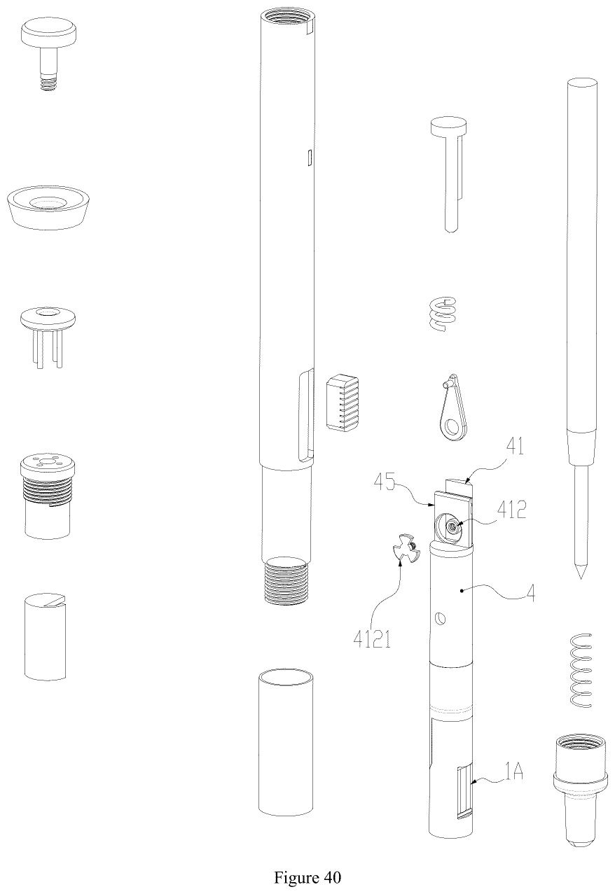

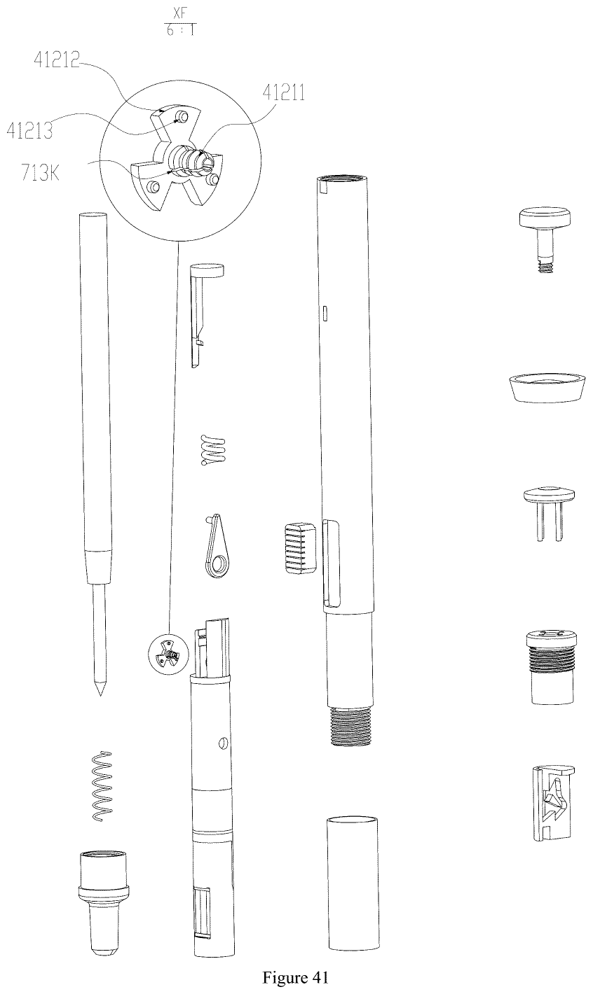

A mechanical pencil as shown in FIGS. 37-41, comprising an sleeve 1, a resetting part 3, a tool body 5, a control part 2, an adjusting part 4 and a positioning part 7; a positioning slot 71 is provided in the positioning part 7; A displacement part 41 is provided on the adjusting part 4, and the displacement part 41 is movably provided in the positioning slot 71.

A lateral pushing portion 4A is provided on the adjusting part 4; a lateral pushing groove 1A for allowing the lateral pushing portion 4A to slide is provided in the sleeve 1; with the lateral pushing portion 4A, the adjusting part 4 can be completely hidden in the sleeve 1 or parts of the adjusting part 4 can be exposed, and in the meanwhile, lead driving and lead retraction can be done by pulling toward a different direction and lead driving and lead retraction can be done by having the lateral pushing portion 4A to control the adjusting part 4.

A trigger assembly 6 is provided on the sleeve 1.

A cover 14 is provided on the sleeve 1, a connection body 11 is provided on the cover 14; the trigger assembly 6 comprises a limiting part 61, a trigger ring 62 and a trigger cover 63; the limiting part 61 passes the trigger cover 63 and is connected with the connection body 11, the trigger cover 63 passes the connection body 11 and is connected with or abutted against the control part 2; the trigger cover 63 moves downwards, the control part 2 will be pressed to move downwards; the trigger ring 62 is located in between the limiting part 61 and the trigger cover 63; at least one trigger assistance diagonal ring C is provided underneath the limiting part 61, above the trigger ring 62, underneath the trigger ring 62 and/or above the trigger cover 63;

A displacement clip 411, a sliding ball groove or a rotation lug 412 is provided on the displacement part 41, at least one sliding ball is provided in between the sliding ball groove and the positioning slot 71; a revolution part 82 is provided on the rotation lug 412, an end of the revolution part 82 is sleeved over the rotation lug 412, the revolution part 82 is rotatable relative to the rotation lug 412, a displacement portion 821 is provided at another end of the revolution part 82, the displacement portion 821, the at least one sliding ball or the displacement clip 411 replace the displacement part 41 to contact directly the positioning slot 71; when it is necessary to move leftward or rightwards, the adjusting part 4 will be driven to move leftward or rightward; A lead retraction limiting ramp 716 and a lead retraction assistance ramp 717 are provided in the positioning slot 71.

An auxiliary resetting part 41 is provided in between the control part 2 and the positioning part 7. A rotation abutment boss 413 for connecting with and adjusting the revolution part 82 is provided on the displacement part 41.

A limiting lug 211 and a control return slope 21A are provided on the control bar 21; the limiting lug 211 replaces the control bar 21 to limit the displacement part 41; when the control bar 21 moves downwards, the displacement part 41 will be influenced by the force of the resetting part 3, moves upwards, and returns to the lead retracted position A via the control return slope 21A; a lead retraction switch wall 711 is provided in the positioning slot 71; a position where the lead retraction switch wall 711 is where the displacement part goes back, and is an area requiring the longest travel, therefore, requirements on the degree of inclination are low, it is easy to fall back, for long distance travelling like this, for the lead driving process, a possibility of changes is higher, by configuring the lead retraction switch wall 11 to change the lead retracted position A to underneath or above the lead driving lug 713, stability when switching from lead retracted to lead driving will be improved; a control slot 715 for allowing the control bar 21 to move up and down is provided on the positioning part 7;

A fall-proof boss 719 is provided in the positioning slot 71, a return passage 71A is provided in between the limiting lug 211 and the fall-proof boss 719 or an inner surface of the sleeve 1 and the limiting lug 211;

An adjusting abutment portion 42 is provided on the adjusting part 4;

The positioning part 7 is provided in between a maximum limiting lug 77 on the sleeve 1 and the cover 14;

A rotation fastener 4121 is provided on the rotation lug 412; a rotation fitting portion 21311, at least one pressure petal 41212 and at least one pressure collar 41213 are provided on the rotation fastener 4121; the at least one pressure collar 41213 is abutted against the revolution part 82, the at least one pressure petal 41212 provides elastic resilience, and the rotation fitting portion 41211 can be fitted into the rotation lug 412 so as to have the rotation fastener 4121 to be stably fixed on the rotation lug 412.

A rotation stabilizing boss 45 is provided on the adjusting part 4; a rotation abutment boss 413 for connecting with and adjusting the revolution part 82 is provided on the displacement part 41.

### Installation Method:

1. Assembling the adjusting part 4, the revolution part 82 and the positioning part 7 to be the adjusting assembly, and installing the adjusting assembly into the sleeve 1;
2. Installing the auxiliary resetting part 31, the control part 2, the cover 14, the trigger cover 63, the trigger ring 62 and the limiting part 61 into the sleeve 1; the cover 14 is in threaded connection with the sleeve 1, and the limiting part 61 and the connection body 11 on the cover 14 engage via threads;
3. Passing the lateral pushing portion 4A through a side of the sleeve 1, and fitting the lateral pushing portion onto the adjusting part 4;
4. Finally installing the tool body 5, the resetting part 3, a grip T and a lead replacement portion into the adjusting part, and engaging the lead replacement portion with the sleeve 1.

For driving the lead the pulling lead driving solution two is used: controlling the adjusting part 4 to move downwards by applying an external force, moving the displacement part 41 from the lead retracted position A downwards, subjected to the influence of the lead driving guiding ramp 7132, the displacement part 41 enters the lead driving channel B2, reaches above the lead driving position B via the long switch ramp 71B, and at this time, releasing the external force, the displacement part 41 will fall back to the lead driving position B, the lead driving is done.

For lead retraction, the following two ways are used simultaneously:
1. Pulling lead retraction solution one: controlling the adjusting part 4 to move downwards by applying an external force on the lateral pushing portion 1A, the displacement part 41 will continue to move downwards, and pass the lead retraction assistance ramp 717 in the positioning slot 71, in this way, the displacement part 41 will return to the lead retracted position A after being free from the limitation of the limiting lug 211 with the resilience of the resetting part 3;
2. Trigger lead retraction solution one: collecting external forces via the trigger ring, transmitting the external force on the trigger ring to the control part via the trigger cover, moving the control part 2, so that the displacement part 41 is free from limitation of the control part 2, the displacement part 41 will be moved influenced by the resetting part 3 and the lead is retracted.

The lead driving solution used in the present embodiment, is different from those in the other embodiments in that, the adjusting part 4 does not operate at the tail end nor at the front end, the adjusting part 4 is operated on a side therefore, with the assistance of the lateral pushing portion 4A, the lateral pushing portion 4A is integrally formed with the adjusting part or individually manufactured, when the lateral pushing portion 4A is integrally formed, it is necessary to promise that the lateral pushing portion 4A is deformable backwards relative to the adjusting part 4 so as to ease installation, and in the present embodiment the lateral pushing portion is an individual part.

Some points to note for all of the embodiments 1-8:
1. Surfaces of the control bar 21 and the trigger ring shall be as smooth as possible, so as to reduce friction, the force required for triggering can thus be reduced and the trigger effect can be further improved.
2. In the embodiments 2 and 3, to engage with the return assistance slope 213, a small return slope 7133 is provided on the lead driving lug 713.
3. The small return slope 7133 has a small degree of inclination and area, so that the lead driving lug 713 can work with the displacement part 41 effectively.
4. To ease engagement between the lead driving lug 713 and the lead driving assistance slope B1, a small lead driving slope 7134 is provided on the lead driving lug 713, and the small lead driving slope 7134 has a small degree of inclination and area, and will not influence engagement between the displacement part 41 and the long switch ramp 71B.
5. To ensure the overall structural stability, when the positioning slot 71 is provided on the sleeve 1, a lead retraction limiting wall 712 is provided on the sleeve 1. When the positioning slot 71 is provided in the positioning part 7, a lead retraction limiting wall 712 is provided in the positioning slot 71, or alternatively, an inner surface of the sleeve 1 serves as the lead retraction limiting wall 712 to limit movement.
6. An outer diameter of the trigger ring 62 is bigger than an outer diameter of the sleeve 1. An extension bar 23 is provided at a lower end portion of the control part
2. A trigger plane 621 is provided at a lower end of the trigger ring 62. The extension bar 23 can fulfill the internal structure, prevent the adjusting part 4 from shaking and/or leaving the sleeve 1, and can also prevent the control part 2 from unnecessary shaking and rotation, also limit the control part 2 and stabilize the internal structures. An inclination of the trigger plane can be dictated by a predetermined trigger inclination degree, for example, when inclining for 10°, trigger lead retraction can be done, in this regard, the inclination of the trigger plane is bigger than 10° so as to improve trigger effects.
7. To ease lead replacement and installation, a lead replacement portion D can be provided at a front end portion of the adjusting part or the sleeve.
8. The tool body 5 comprises a housing tool, usually all kinds of leads.
9. The essence of the resetting part 3 is to provide a continuous force, therefore, the resetting part 3 and the auxiliary resetting part 31 comprise flexible materials, magnetically attractive substances, magnetically attractive materials, elastic materials and/or resetting springs in combination or individually, as shown in most of the drawings, they are springs.
10. An elastic force of the auxiliary resetting part 31 is smaller than the elastic force of the resetting part 3.

### Special Remarks:

1. In the embodiments: “the control bar 21 can make up and down or forward and backward movement relative to the positioning slot 71 and cannot move leftward and rightward movement.” This limitation is given in consideration of actual conditions in the embodiments, in view of writing stability, and this does not mean that, this is the only way, the movements can be obliquely up, obliquely down, obliquely forward, obliquely backward, leftward and rightward, the operation experience may be inferior, and in the internal structures, additional guiding structures for matching the operation directions shall be designed, further, when choosing to maintain the adjusting part unmoved, the positioning part 7 shall be rotatable, in such case, the positioning part 7 is rotatable relative to the sleeve, that is to say, the solution of having the positioning part 7 being rotatable falls into the protection scope of the present invention too.
2. With regard to the relationship between the control part 2, the adjusting part 4, the positioning part 7 and the trigger assembly, as extension properties of these parts are good, there may be alterations, therefore, possibilities of the spatial relationships are a lot, there is no absolute spatial relationship, and this is configured to realize the operation methods and design idea of the present invention.
3. There are many different ways to maintain the adjusting part 4 in position after being installed into the sleeve 1, for example, limitation of the positioning slot 71, the positioning portion 72, the positioning part 7 and/or the control bar on the adjusting part 4 and limitations of their derivatives on the adjusting part 4, and this is readily known by on of ordinary skill in the art, therefore, detailed description is not given to similar conditions. For example, in the embodiment 1, by fitting the revolution part 82 in between the rotation lug on the displacement part 41 and the positioning part 71, the adjusting part 4 can be prevented from leaving the sleeve 1.
4. When the displacement part 41 deforms, deformation space shall be reserved for the displacement part 41, and the deformation space can be configured as per actual conditions to allow the displacement part 41 to deform, and one of ordinary skill in the art can figure out the deformation due to backward movement during deformation; for example, in the embodiment, by providing a deformation slot 231 on the extension bar 23, the deformation due to backward movement when the displacement clip 411 passes the lead driving lug 713 and is deformed.
5. With regard to preventing the control bar 21 from leftward or rightward movement, a corresponding clip is provided on the sleeve, in the meanwhile, a corresponding clip is provided on the control bar 21, rotation prevention can be realized. With regard to the maximum upward movement limitation and the maximum downward movement limitation of the control bar 21, by configuring corresponding clips in the sleeve this can be done, therefore, it is only necessary to know specific positions of the maximum upward movement limitation and the maximum downward movement limitation.
6. When the control part 2 retracts the lead by moving upwards, even when no auxiliary resetting part 31 is provided in between the control part 2 and the trigger assembly 6 the control part 2 is usable, the gravity of the control part 2 can be used to move downward to resume to the original position, it is only necessary to ensure that the friction of portions of the sleeve 1 relevant to sliding of the control part 2 is small, while the control part 2 has itself the gravity, the effect is better. To promise better operation stability, preferably the auxiliary resetting part 31 is used, it is not required for the auxiliary resetting part 31 to have a bigger resilience, the resilience is required to be sufficient to reset the control part 2.
7. The two pulling lead driving methods can exist at the same time as the trigger lead retraction, when this is done by internal structures, the method in the embodiment 1 is preferred, when it is exposed for users, the method in the embodiment 3 can be used, when pressing to propel the lead, the embodiment 2 can be used, apparently, there are a plurality of specific possible combinations, and details are to be optimized, however, without departing from the essence and the principle of the present invention, modifications and improvements made shall be deemed to fall into the protection scope of the present invention.
8. In the positioning slot 71, there are more passages than those named in the present invention, for example, a lead retraction return passage exists in between the lead driving lug 713 and the lead retraction switch wall 711, this common passage is not described in the present invention, it shall be understood that, the passage in the positioning slot 71 is sufficient for allowing the displacement part 41 and corresponding variations thereof to pass.
9. When the trigger assembly is not used, the control bar is operated individually, a part similar to the trigger cover 63 shall be provided on the sleeve 1 to engage with the sleeve, the part similar to the trigger cover 63 can be integral with the sleeve, therefore, no separate explanation is given, a through-hole is provided at an intermediate portion of the part similar to the trigger cover 63, it is sufficient for the control bar to be exposed out of the through-hole, and can be touched by users, similar to those in the embodiment 4.
10. With regard to included angles between the the lead retraction switch wall 711, the long switch ramp 71B, the lead retraction limiting wall 712, the lead driving wall 7131, the control switch wall 212, the lead retraction assistance ramp 717 and/or the lead driving guiding ramp 7132 and the horizontal plane, the included angle is generally 15° to 80°, the lead retraction limiting wall 712 can be 90° or other degrees; generally, degrees close to 45° are preferable, for example, 50°, 40°, 55°, 60°, 58°, 42°, 35° and/or 65° or equivalents, and the specific degrees shall be dictated by the lead driving travelling course of the pencil and the lead retraction travelling course of the pencil, the actual degrees can be determined at the time of commissioning.
11. With regard to the lengths of the lead retraction switch wall 711, the lead retraction assistance ramp 717, the long switch ramp 71B, the lead retraction limiting wall 712, the lead driving sliding wall 7131, the control switch wall 212 and/or the lead driving guiding ramp 7132, and spatial relationship thereof in the positioning slot, the consideration is to promise passage of the displacement part 41 and the tolerance; for example: a linear distance from an end point of the lead driving sliding wall 7131 close to the lead driving position B to the long switch ramp 71B shall be bigger than an outer diameter of the displacement part 41, so as to promise smooth passage of the displacement part; a horizontal distance from an end point of the lead driving wall 7131 far from the lead driving position B to an end point of the lead retraction limiting ramp 716 close to the lead driving sliding wall 7131 shall be bigger than a width of the displacement part, so as to ensure that the displacement can contact stably the lead driving sliding wall 7131 during upward or downward movement; and similarly in other cases.
12. When the control switch wall is not used, the long switch ramp or the lead retraction assistance ramp shall be extend for a certain distance upward or downward, to ensure to be underneath or above the limiting lug; so that when the displacement part or equivalent parts of the displacement part pass, the influence of the limiting lug can be avoided, the pulling solution one can be realized; and by configuring the limiting return slope coverage on the long switch slope or the lead retraction assistance ramp can be reduced, as the limiting return slope can play a certain slope guiding role.
13. In some embodiments, the positioning part 7 and the trigger cover 63 can be integrally manufactured as per actual conditions and molding cost and installation work can be saved.
14. To enable the revolution part to balance the negative interference due to the gravity, preferably, this is done by the structure of the adjusting part, for example, including a clamping structure for the adjusting part, to clamp the revolution part from a front portion and a rear portion of the revolution part, the revolution part does no longer require clamping of the adjusting part and the positioning part, by clamping with the adjusting part, the stability is higher, and the requirements on the accuracy of the displacement portion 821 will be greatly reduced; there are a lot of methods as to how to balance the revolution part against the gravity, for example: (1) including coarse grains on the rotation lug 412, increasing frictions in between the revolution part 82 and the rotation lug 412 and balance the negative influence of the gravity; (2) including a flexible part to limit the revolution part; (3) providing magnetic attraction to the revolution part via magnets to counteract the interference of the gravity; (4) increasing the friction of the positioning slot; (5) configuring the positioning slot to be in different layers to prevent the revolution part from moving back and forth; and (6) including steps on the displacement part to constrain the revolution part.
15. The long switch ramp has primarily two functions, the first function is to help lead driving, the second is to help lead retraction; the two functions look different, they can exist individually or simultaneously, in specific conditions, the functions can be determined as per actual requirements, to be more stable and tolerant, when replacing the role of helping lead retraction of the long switch ramp 71B with the lead retraction assistance ramp 717, the long switch ramp 71B serves only to help lead driving; and in the embodiment 5, the long switch ramp provides only the lead retraction assistance function as lead driving assistance role is not required.
16. To further improve the stability of the control part 2, the control slot for housing the control bar 21 can be extended for a certain distance upwards or backwards, to be a deep control slot 7151, a head portion of the control bar 21 can be extended, in this case, even in case of the triggered state, when the control part 21 is moved upward or downward to a maximum distance, the head portion of the control bar 21 can be maintained in the deep control slot 7151, so that when the displacement part 41 falls back, a hollow space will not be formed in the positioning slot, the overall running stability will be promised.
17. The limiting lug 211 is a part of the control bar 21, the limiting lug 21 replaces the function of the control bar 21 for limitation, and the structure is of importance significance, and shall not be simply considered to be a simple extension of the control bar 21, as the function of the present invention is upgraded significantly due to the appearance of the limiting lug 211, a plurality of lead retraction methods are obtained, and this is a key technical point for pulling lead retraction and pressing lead retraction, the return assistance slope 213 further supplements and extends the limiting lug 211 to provide more functions; by providing the limiting lug 211 to be an individual part or replaced with similar structures belongs to equivalent replacement; for those of ordinary skill in the art, equivalent replacement of other similar parts of the present invention shall be deemed to fall into the protection scope of the present invention.
18. The definition of the term “bypassing” in the description is to go around the limiting lug 21 starting from the lead driving position B, for example, going around the limiting lug 211 for half a round from above or underneath, going to another side of the limiting lug 211 corresponding to the lead driving position B, leaving the original lead driving position B and retracting the lead.
19. The definition of the term “going beyond” in the description is to move over the limiting lug 211 starting from the lead driving position B; as the limiting lug 211 serves to limit the limiting lug 211 temporarily, the adjusting part can go beyond the limiting lug 211 via methods similar to the return assistance slope; however to be safe, the adjusting part preferably does not go beyond the limiting lug 211 starting from the lead driving position B, however, goes beyond the lead driving limiting lug from above or underneath, specifically, to determine to go above or underneath is dependent on an orientation of the positioning slot in the technical solution, and the orientation of the positioning slot is determined based on whether to use the pulling solution or the pressing solution; for example: first of all, going from the lead driving position B to above or underneath the limiting lug 211, thereafter, with the force of the resetting part, the displacement part rises or descends due to the resilience, upon contact with the limiting lug 211, the displacement part 41 passes the return assistance slope, goes beyond the limiting lug 211, reaches another side different from the return assistance slope and the lead is retracted.
20. The role of the positioning portion 72 is to replace the positioning part 7 to be connected with the tool body 5, so that a tail end portion of the tool body 5 can be limited, by displacement of the adjusting part, lead driving and retraction can be accurately controlled; therefore, the positioning portion 72 can be integrally formed with the sleeve, and can be separated to be independent parts, and installed into the sleeve as an accessory;
21. To enhance trigger, although the control bar 21 is abutted against and limits the displacement part 41, the main bearing point is designed at the lead driving lug 713 in the positioning slot, the lead driving lug 713 bears the force of the resetting part 3, so as to guarantee that the force required for withdrawing the control bar 21 to free the limitation and realize trigger lead retraction is only a connection force.
22. As can be seen in the embodiments 1 and 7, the engagement methods between the revolution part 82 and the rotation lug 412 can be diversified, and are not limited to providing a hole on the revolution part 82 to be sleeved over the rotation lug 412, in other cases, a rotation lug 412 is provided on the revolution part 82, a rotation through-hole 41F is provided on the displacement part 41 and the rotation lug 412 on the revolution part 82 is installed in the rotation through-hole 41F for subsequent use.
23. The structural alteration possibilities in the present invention are a lot, therefore, the engagement relationships, the positional relationships, the parts actually operated on, the portions that are directly connected, whether to provide the lead replacement portion in the sleeve or the inner shaft, the different application conditions of the cover and structural variations of the sleeve can be determined as per actual conditions, and here are some changes that attention shall be paid to:
(1) The part that the tail portion of the tool body is abutted against can be a bottom portion of the positioning part, an adjusting and connection portion of the adjusting part, or a positioning portion of the sleeve; correspondingly, when the tail end of the tool body is abutted against the bottom portion of the positioning part or the positioning portion of the sleeve, movements of the adjusting part will directly dictate exposure and lead retraction of the tool body, front ends of the resetting part and the tool body are basically in the adjusting part, and when the tail end of the tool body is rested on the adjusting and connection portion of the adjusting part, movements of the adjusting part will indirectly dictate the exposure and lead retraction of the tool body, and at this time, the front ends of the resetting part and the tool body are basically in the sleeve;
(2) The auxiliary resetting part can be provided in between the control part and the cover, in between the positioning part and the control part, in between the control part and the sleeve, in between the control part and the trigger cover or in between the control part and the adjusting part; when in different positions, many corresponding structures will be changed;
(3) The operation portions are variable too, the operations can be done at front portions, tail portions, laterally, 360° trigger operation, pencil clamping operation, pressing operation, thrust operation or laterally pulling operation; and for pressing operations there are many conditions;
(4) A position of the positioning slot is variable too, the positioning slot can be configured on the positioning part or the sleeve, the visual effect brought and actual fabrication conditions will also be different;
(5) A shape and structure of an opening of the positioning slot is variable too, structures of the positioning slot can be changed in a plurality of manners depending on differences of required operations and functions;
(6) The control part is changeable too, a shape and structure of the control part can be changed in a plurality of ways, changes of the control part is dictated by changes of influences and interference of the positioning slot, required operations and installation orientations, in addition, by providing additionally some stabilizing structures for the control part, stability of the adjusting part can be improved;
(7) The pressing bar is changeable too, the pressing bar can be determined to be manufactured integrally, fixedly or rotatably installed according to the process, fabrication and required operation effects, for rotation installation, one end can be fixed, another end rotatable, or the intermediate portion is fixed while two ends are rotatable;
(8) The trigger assembly is variable, for the trigger assembly, it is possible to select to move the limiting part or the trigger cover as required, or to move via the trigger bar, the trigger ways in the present invention can be different and in the present invention only some are listed;
(9) The sleeve is variable, the tail portion can be replaced by a cover or a rotation part, also the connection body, the pressing bar, the pencil clip, the lead replacement portion and/or the positioning portion can be provided;
(10) The adjusting part is variable, for the adjusting part, the change realized can be big, the functions and effects realized can be different, it is possible to have some of the adjusting part exposed out of the sleeve, also some of the adjusting part exposed from a lower portion of the sleeve, also it is possible to have a side of the adjusting part exposed out of the sleeve, or have the adjusting part hidden in the sleeve completely; shapes and structures of the adjusting part can be varied accordingly, for example, in the embodiments, shapes of the adjusting parts look not similar, as the adjusting part can realize big changes, the functions and effects are big, to configure the adjusting part to be different, many lead driving operations and lead retraction operations can be realized, many different lead driving operations or many different lead retraction operations can exist at the same time; although the adjusting part is changeable to a large extent, they can be summarized to be the same part, and to be changeable is to make adaptive adjustment according to actual conditions and requirements.

What is claimed is:

1. A mechanical pencil, comprising a sleeve (1), an adjusting part (4), a tool body (5), a resetting part (3) and a control part (2); wherein a displacement part (41) is provided on the adjusting part (4) and the displacement part (41) is movable in a positioning slot (71); by displacing of the adjusting part (4) in the sleeve (1), a position-based state of the tool body (5) is selected between a lead driving state and a lead retraction state, and the adjusting part (4) is configured to maintain relative stability of the two position-based states by the positioning slot (71), the resetting part (3) and the control part (2); the resetting part (3) keeps the lead retraction state of the displacement part (41) on the adjusting part (4) at a lead retracted position (A) relatively stable; when the displacement part (41) moves in the positioning slot (71) to a lead driving position (B), the displacement part (41) is maintained at a lead driving state stably by the control part (2);
wherein the lead is retractable by at least influencing the movement of the control part (2) by applying an external force, causing the displacement part (41) be free from limitation of the control part (2), the displacement part (41) is thereby moveable under the action of the resetting part (3) to retract the lead.

2. The mechanical pencil according to claim 1, wherein the mechanical pencil further comprises a positioning part (7), a trigger assembly (6) provided on the sleeve (1), wherein the movement of the control part (2) is caused by the transmission of the trigger assembly (6) to retract the lead;
the positioning slot (71) is provided in the positioning part (7); a lead driving lug (713) and a lead retraction switch ramp (711) are provided in the positioning slot (71); a control bar (21) is provided on the control part (2); lead retraction is carried out by the displacement part (41) through one of five ways as follows:
(1) lead retraction solution 1: a limiting lug (211) is provided on the control bar (21); a long switch ramp (71B) is provided in the positioning slot (71), the limiting lug (211) replaces the control bar (21) to limit the displacement part (41); when retracting the lead, the displacement part (41) moves upwards or downwards, by the long switch ramp (71B) the displacement part (41) bypasses limitation of the limiting lug (211), subsequently the displacement part (41) passes the lead retraction switch ramp (711) and returns to the lead retracted position (A);
(2) lead retraction solution 2: a limiting lug (211) is provided on the control bar (2); a long limiting ramp (71B) is provided in the positioning slot (71), and the limiting lug (211) replaces the control bar (21) to limit the displacement part (41); a return assistance slope (213) is provided on the limiting lug (211); the displacement part (41) moves upwards or downwards, reaches above or underneath the limiting lug (211) by the long switch ramp (71B), subsequently, the displacement part (41) bypasses limitation of the limiting lug (211) and returns to the lead retracted position (A) by the lead retraction switch ramp (711);
(3) lead retraction solution 3: a limiting lug (211) and a return control ramp (21A) are provided on the control bar (21); the limiting lug (211) replaces the control bar (21) to limit the displacement part (41); when the control bar (21) moves downwards, the displacement part (41) is subjected to force of the resetting part (3), moves upwards, and returns to the lead retracted position (A) by the return control ramp (21A);
(4) movement controlled lead retraction: by applying an external force to force the control part (2) to move, the displacement part (41) will be free from limitation of the control part (2), the displacement part (41) is thus influenced by the resetting part (3) to move upwards or downwards, consequently, limitation of the control part (2) on the displacement part (41) is released, the displacement part (41) passes the lead retraction switch ramp (711) and returns to the lead retracted position (A) to retract the lead; or
(5) pushing lead retraction: a pushing assistance slope (417) is provided on the displacement part (41) and/or the lead driving lug (713); maintaining the sleeve (1) unmoved, pushing the adjusting part (4) to move downwards with an external force, with the pushing assistance slope (417) the displacement part (41) is free from limitation of the lead driving lug (713) and returns to the lead retracting position (A).

3. The mechanical pencil according to claim 1, wherein:
a lateral pushing portion (4A) is provided on the adjusting part (4); a lateral pushing slot (1A) for housing the lateral pushing portion (4A) to slide is provided in the sleeve (1); a fall-proof lug (719) is provided in the positioning slot (71), a return channel (71A) is provided in between the limiting lug (211) and the fall-proof lug (719) or in between an inner surface of the sleeve (1) and the limiting lug (211);
a lead driving limiting ramp (716) and a lead retraction assistance ramp (717) are provided in the positioning slot (71);
lateral pushing lead retraction solution 1: applying an external force on the lateral pushing portion (1A) to control the adjusting part (4) to move downwards, the displacement part (41) will continue to move downwards, subsequently, the displacement part (41) bypasses limitation of the limiting lug (211) after passing the lead retraction assistance ramp (717) in the positioning slot (71), and returns to the lead retracted position A through resilience of the resetting part (3).

4. The mechanical pencil according to claim 1, wherein the trigger assembly (6) comprises a limiting part (61), a trigger ring (62) and a trigger cover (63); the limiting part (61) extends through the trigger cover (63) and is connected with the control part (2), the control part (2) moves along with the limiting part (61); by pressing the trigger ring (62) with an external force, the trigger ring (62) presses the trigger cover (63), the trigger cover (63) presses the control part (2), the control part (2) causes the displacement part (41) to move inwards, consequently, the displacement part (41) leaves the lead driving lug (713) and the displacement part (41) returns to the lead retracted position (A) by the resetting part (3).

5. The mechanical pencil according to claim 4, wherein:
the trigger assembly (6) carries out lead driving and retraction in at least one of the three ways as follows:
(1) the trigger assembly (6) comprises the limiting part (61), the trigger ring (62) and the trigger cover (63); the limiting part (61) extends through the trigger cover (63) and is connected with the control part (2), and the control part (2) moves along with the limiting part (61); the trigger cover (63) is connected with the sleeve (1); the trigger ring (62) is located in between the limiting part (61) and the trigger cover (63); at least one trigger assistance diagonal ring (C) is provided underneath the limiting part (61), above the limiting ring (62), underneath the trigger ring (62) and/or above the trigger cover (63);
(2) a connection body (11) is provided on the sleeve (1); the trigger assembly (6) comprises the limiting part (61), the trigger ring (62) and the trigger cover (63); the limiting part (61) extends through the trigger cover (63) and is connected with the connection body (11), the trigger cover (63) extends through the connection body (11) and is connected with or abutted against the control part (2); when the trigger cover (63) moves downwards, the control part (2) is pressed to move downwards; the trigger ring (62) is located in between the limiting part (61) and the trigger cover (63); at least one trigger assistance diagonal ring (C) is provided underneath the limiting part (61), above the trigger ring (62), underneath the trigger ring (62) and/or above the trigger cover (63); and
(3) the trigger assembly (6) comprises the limiting part (61) and the trigger ring (62); the limiting part (61) extends through the sleeve (1) and is connected with the control part (2), and the control part (2) moves along with the limiting part (6); the trigger ring (62) is located in between the limiting part (61) and the sleeve (1); and at least one trigger assistance diagonal ring (C) is provided on the limiting part (61), the trigger ring (62) and/or the sleeve (1).

6. The mechanical pencil according to claim 2, wherein:
a solution for moving the displacement part (41) in the positioning slot (71) from the lead retracted position (A) to the lead driving position (B) is carried out by any of three ways as follows:
(1) the long switch ramp (71B) is provided in the positioning slot (71), a lead driving assistance ramp (B1) is provided at an end of the lead driving lug (713) close to the lead retracted position (A) and/or an end of the displacement part (41) close to the lead driving position (B), the displacement part (41) is capable of deformation and bending forward and backward, when the displacement part (41) extends through the lead driving lug (713), with deformation and bending ability of the displacement part (41) and the lead driving assistance ramp (B1), the displacement part (41) bypasses the lead driving lug (713) and reaches the lead driving position (B);
(2) the long switch ramp (71B) and a lead driving sliding ramp (7131) are provided in the positioning slot (71), a lead driving guiding ramp (7132) is provided on a side of the lead driving lug (713) close to the lead retracted position (A); a lead driving channel (B2) is provided in between the long switch ramp (71B) and the lead driving lug (713); when the displacement part (41) moves from the lead retracted position (A), subjected to influence of the lead driving guiding ramp (7132), the displacement part (41) enters the lead driving channel (B2), and reaches above or underneath the lead driving position (B), at this time, releasing the external force, the displacement part (41) will return to the lead driving position (B); and
(3) a long switch ramp (71B) is provided in the positioning slot (71), a lead driving sliding ramp (7131) is provided on the lead driving lug (713), a lead driving channel (B2) is provided at a side of the lead driving lug (713) close to the lead retracted position (A); when the displacement part (41) moves from the lead retracted position (A), the displacement part (41) enters directly the lead driving channel (B2), passes the long switch ramp (71B) and reaches above or underneath the lead driving position (B), and at this time, releasing the external force, the displacement part (41) falls back to the lead driving position (B).

7. The mechanical pencil according to claim 1, wherein:
there are two stable position-based relationships of the displacement part (41) in the positioning slot (71);
a lead retraction state, at this time, subjected to the influence of the resetting part (3), the displacement part (41) is at the least retraction position (A) in the positioning slot (71);
a lead driving state, at this time, subjected to limitation of the control part (2), the displacement part (41) overcomes action of the resetting part (3) and located stably at the lead driving position (B) in the positioning slot (71).

8. The mechanical pencil according to claim 2, wherein:
solutions for moving the displacement part (41) leftward or rightward in the positioning slot (71) comprise any of at least eight solutions as follows:
(1) a movable slot is provided in the displacement part (41), at least one sliding ball is provided in between the movable slot and the positioning slot (71); the at least one sliding ball replaces the displacement part (41) to directly contact the positioning part (71);
(2) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved over the rotation lug (412), the revolution part (82) is rotatable relative to the rotation lug (412), a displacement portion (821) is provided on another end of the revolution part (82), the displacement portion (821), the at least one sliding ball or the displacement clip (411) replaces the displacement part (41) to directly contact the positioning slot (71);
(3) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved over the rotation lug (412), the revolution part (82) is rotatable relative to the rotation lug (412), a displacement portion (821) is provided at another end of the revolution part (82), the displacement portion (821), the at least one sliding ball or the displacement clip (411) replaces the displacement part (41) to contact directly the positioning slot (71); the displacement part (41) is capable of leftward and rightward deformation and bending, and is bendable for a certain extent, consequently, when the displacement part (41) moves in the positioning slot (71), without moving the adjusting part (4), the displacement part (41) can move leftward or rightward;
(4) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved onto the rotation lug (412), the revolution part (82) is rotatable relative to the rotation lug (412), a displacement portion (821) is provided at another end of the revolution part (82), the displacement portion (821), the at least one sliding ball or the displacement clip (411) replaces the displacement part (41) to contact directly the positioning slot (71); when to move leftward and rightward, the adjusting part (4) will move leftward and/or rightward;
(5) the displacement part (41) is independent from the adjusting part (4), a displacement clip (411), a sliding ball slot, a movable slot or a rotation lug (412) is provided on the displacement part (41), at least one sliding ball is provided in between the movable slot or the sliding ball slot and the positioning slot (71); a revolution part (82) is provided on the rotation lug (412), an end of the revolution part (82) is sleeved onto the rotation lug (412), the revolution part (82) is rotatable relative to the rotation lug (412), a displacement portion (821) is provided on another end of the revolution part (82), the displacement portion (821), the at least one sliding ball or the displacement clip (411) replaces the displacement part (411) to contact directly the positioning slot (71); the displacement part (41) and the adjusting part (4) engage by magnetic adsorption, clearance fit, abrasives and/or threaded connection;
(6) a rotation lug (412) is provided on the displacement part (41), a revolution part (82) is provided on the rotation lug (412), an end of the revolution part (82) is installed on the rotation lug (412), the revolution part (82) is rotatable relative to the rotation lug (412), a displacement portion (821) is provided at another end of the revolution part (82) and the displacement portion (821) replaces the displacement part (41) to contact directly the positioning slot (71);
(7) a rotation through-hole (41F) is provided on the displacement part (41), a revolution part (82) is provided in the rotation through-hole (41F), the revolution part (82) is rotatable relative to the rotation through-hole (41F), a displacement portion (821) is provided at another end of the revolution part (82), and the displacement portion (821) replaces the displacement part (41) to contact directly the positioning part (71); and
(8) with assistance of third-party accessories, the displacement part (41) can move leftward or rightward in the positioning slot (71).

9. The mechanical pencil according to claim 1, wherein:
an auxiliary resetting part (31) is provided in between the control part (2) and the adjusting part (4); alternatively, the auxiliary resetting part (31) is provided in between the control part (2) and the sleeve (1);
at least one adjusting hole (E1) is provided at where the adjusting part (4) is connected with the tool body (5), and an adjustable base (E) is provided in the at least one adjusting hole (E1);
in the positioning slot (71) a plurality of dislocated layers are configured;
an installation cushioning slot (7D) and/or a lead retraction tolerance slot (7F) is provided in the positioning part (71);
when the positioning slot (71) is provided in the sleeve (1), a lead retraction limiting ramp (712) is provided on the sleeve (1);
an extension bar (23) is extended on a lower end portion of the control part (2);
when the displacement part (41) is not replaced with the at least one sliding ball, the revolution part (82) or any third-party accessories, the displacement part (41) is configured to be in a shape of an inverted hook.

10. The mechanical pencil according to claim 2, wherein:
where the lead retraction solution one is used, a control switch ramp (212) is provided on the control part (2); a lead retraction channel (214) is provided in between the limiting lug (211) and the long switch ramp (71B) and/or the lead retraction channel (214) is provided in between the limiting lug (211) and the control switch ramp (212);
where the lead retraction solution two is used, the lead retraction channel (214) is provided in between the control part (2) and the long switch ramp (71B).

11. The mechanical pencil according to claim 8, wherein, in the solution (7), a rotation stabilizing lug (45) is provided on the adjusting part (4); a rotation abutment boss (413) for connecting with and adjusting the revolution part (82) is provided on the displacement part (41) and/or an abutment lug for connecting with and adjusting the revolution part (82) is provided on the positioning part (7); a rotation assistance boss (822) and/or a rotation installation notch (823) is provided on the revolution part (82); a deformation groove (713K) is provided on the lead driving lug (713), the positioning part (7), the displacement part (41), the sleeve (1), the revolution part (82) and/or the rotation installation notch (413).

12. The mechanical pencil according to claim 8, wherein at least one rotation stopper (4121) is provided on the displacement part (41), the rotation lug (412), in the rotation through-hole (41F) and/or on the revolution part (82).

13. The mechanical pencil according to claim 2, wherein:
an outer diameter of the trigger ring (62) is greater than an outer diameter of the sleeve (2);
a trigger slide (621) is provided on a lower end of the trigger ring (62);
an auxiliary resetting part (31) is provided in between the control part (2) and the positioning part (7);
where the positioning slot (71) is provided on the positioning part (7), a lead retraction limiting ramp (712) is provided in the positioning slot (71) or an inner surface of the sleeve (1) serves as the lead retraction limiting ramp (712).

14. The mechanical pencil according to claim 2, wherein the trigger assembly (6) comprises a limiting part (61), a trigger ring (62) and a trigger cover (63); the limiting part (61) extends through the trigger cover (63) and is connected with the control part (2), the control part (2) moves along with the limiting part (61); by pressing the trigger ring (62) with an external force, the trigger ring (62) presses the trigger cover (63), the trigger cover (63) presses the control part (2), the control part (2) causes the displacement part (41) to move inwards, consequently, the displacement part (41) leaves the lead driving lug (713) and the displacement part (41) returns to the lead retracted position (A) by the resetting part (3).

15. The mechanical pencil according to claim 3, wherein the trigger assembly (6) comprises a limiting part (61), a trigger ring (62) and a trigger cover (63); the limiting part (61) extends through the trigger cover (63) and is connected with the control part (2), the control part (2) moves along with the limiting part (61); by pressing the trigger ring (62) with an external force, the trigger ring (62) presses the trigger cover (63), the trigger cover (63) presses the control part (2), the control part (2) causes the displacement part (41) to move inwards, consequently, the displacement part (41) leaves the lead driving lug (713) and the displacement part (41) returns to the lead retracted position (A) by the resetting part (3).

16. The mechanical pencil according to claim 14, wherein:
the trigger assembly (6) carries out lead driving and retraction in at least one of the three ways as follows:
(4) the trigger assembly (6) comprises the limiting part (61), the trigger ring (62) and the trigger cover (63); the limiting part (61) extends through the trigger cover (63) and is connected with the control part (2), and the control part (2) moves along with the limiting part (61); the trigger cover (63) is connected with the sleeve (1); the trigger ring (62) is located in between the limiting part (61) and the trigger cover (63); at least one trigger assistance diagonal ring (C) is provided underneath the limiting part (61), above the limiting ring (62), underneath the trigger ring (62) and/or above the trigger cover (63);
(5) a connection body (11) is provided on the sleeve (1); the trigger assembly (6) comprises the limiting part (61), the trigger ring (62) and the trigger cover (63); the limiting part (61) extends through the trigger cover (63) and is connected with the connection body (11), the trigger cover (63) extends through the connection body (11) and is connected with or abutted against the control part (2); when the trigger cover (63) moves downwards, the control part (2) is pressed to move downwards; the trigger ring (62) is located in between the limiting part (61) and the trigger cover (63); at least one trigger assistance diagonal ring (C) is provided underneath the limiting part (61), above the trigger ring (62), underneath the trigger ring (62) and/or above the trigger cover (63); and
the trigger assembly (6) comprises the limiting part (61) and the trigger ring (62); the limiting part (61) extends through the sleeve (1) and is connected with the control part (2), and the control part (2) moves along with the limiting part (6); the trigger ring (62) is located in between the limiting part (61) and the sleeve (1); and at least one trigger assistance diagonal ring (C) is provided on the limiting part (61), the trigger ring (62) and/or the sleeve (1).

17. The mechanical pencil according to claim 15, wherein:
the trigger assembly (6) carries out lead driving and retraction in at least one of the three ways as follows:
(6) the trigger assembly (6) comprises the limiting part (61), the trigger ring (62) and the trigger cover (63); the limiting part (61) extends through the trigger cover (63) and is connected with the control part (2), and the control part (2) moves along with the limiting part (61); the trigger cover (63) is connected with the sleeve (1); the trigger ring (62) is located in between the limiting part (61) and the trigger cover (63); at least one trigger assistance diagonal ring (C) is provided underneath the limiting part (61), above the limiting ring (62), underneath the trigger ring (62) and/or above the trigger cover (63);
(7) a connection body (11) is provided on the sleeve (1); the trigger assembly (6) comprises the limiting part (61), the trigger ring (62) and the trigger cover (63); the limiting part (61) extends through the trigger cover (63) and is connected with the connection body (11), the trigger cover (63) extends through the connection body (11) and is connected with or abutted against the control part (2); when the trigger cover (63) moves downwards, the control part (2) is pressed to move downwards; the trigger ring (62) is located in between the limiting part (61) and the trigger cover (63); at least one trigger assistance diagonal ring (C) is provided underneath the limiting part (61), above the trigger ring (62), underneath the trigger ring (62) and/or above the trigger cover (63); and
the trigger assembly (6) comprises the limiting part (61) and the trigger ring (62); the limiting part (61) extends through the sleeve (1) and is connected with the control part (2), and the control part (2) moves along with the limiting part (6); the trigger ring (62) is located in between the limiting part (61) and the sleeve (1); and at least one trigger assistance diagonal ring (C) is provided on the limiting part (61), the trigger ring (62) and/or the sleeve (1).

18. The mechanical pencil according to claim 3, wherein:
solutions for moving the displacement part (41) leftward or rightward in the positioning slot (71) comprise any of at least eight solutions as follows:
(1) a movable slot is provided in the displacement part (41), at least one sliding ball is provided in between the movable slot and the positioning slot (71); the at least one sliding ball replaces the displacement part (41) to directly contact the positioning part (71);
(2) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved over the rotation lug (412), the revolution part (82) is rotatable relative to the rotation lug (412), a displacement portion (821) is provided on another end of the revolution part (82), the displacement portion (821), the at least one sliding ball or the displacement clip (411) replaces the displacement part (41) to directly contact the positioning slot (71);
(3) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved over the rotation lug (412), the revolution part (82) is rotatable relative to the rotation lug (412), a displacement portion (821) is provided at another end of the revolution part (82), the displacement portion (821), the at least one sliding ball or the displacement clip (411) replaces the displacement part (41) to contact directly the positioning slot (71); the displacement part (41) is capable of leftward and rightward deformation and bending, and is bendable for a certain extent, consequently, when the displacement part (41) moves in the positioning slot (71), without moving the adjusting part (4), the displacement part (41) can move leftward or rightward;
(4) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved onto the rotation lug (412), the revolution part (82) is rotatable relative to the rotation lug (412), a displacement portion (821) is provided at another end of the revolution part (82), the displacement portion (821), the at least one sliding ball or the displacement clip (411) replaces the displacement part (41) to contact directly the positioning slot (71); when to move leftward and rightward, the adjusting part (4) will move leftward and/or rightward;
(5) the displacement part (41) is independent from the adjusting part (4), a displacement clip (411), a sliding ball slot, a movable slot or a rotation lug (412) is provided on the displacement part (41), at least one sliding ball is provided in between the movable slot or the sliding ball slot and the positioning slot (71); a revolution part (82) is provided on the rotation lug (412), an end of the revolution part (82) is sleeved onto the rotation lug (412), the revolution part (82) is rotatable relative to the rotation lug (412), a displacement portion (821) is provided on another end of the revolution part (82), the displacement portion (821), the at least one sliding ball or the displacement clip (411) replaces the displacement part (411) to contact directly the positioning slot (71); the displacement part (41) and the adjusting part (4) engage by magnetic adsorption, clearance fit, abrasives and/or threaded connection;
(6) a rotation lug (412) is provided on the displacement part (41), a revolution part (82) is provided on the rotation lug (412), an end of the revolution part (82) is installed on the rotation lug (412), the revolution part (82) is rotatable relative to the rotation lug (412), a displacement portion (821) is provided at another end of the revolution part (82) and the displacement portion (821) replaces the displacement part (41) to contact directly the positioning slot (71);
(7) a rotation through-hole (41F) is provided on the displacement part (41), a revolution part (82) is provided in the rotation through-hole (41F), the revolution part (82) is rotatable relative to the rotation through-hole (41F), a displacement portion (821) is provided at another end of the revolution part (82), and the displacement portion (821) replaces the displacement part (41) to contact directly the positioning part (71); and
(8) with assistance of third-party accessories, the displacement part (41) can move leftward or rightward in the positioning slot (71).

19. The mechanical pencil according to claim 6, wherein:
solutions for moving the displacement part (41) leftward or rightward in the positioning slot (71) comprise any of at least eight solutions as follows:
(1) a movable slot is provided in the displacement part (41), at least one sliding ball is provided in between the movable slot and the positioning slot (71); the at least one sliding ball replaces the displacement part (41) to directly contact the positioning part (71);
(2) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved over the rotation lug (412), the revolution part (82) is rotatable relative to the rotation lug (412), a displacement portion (821) is provided on another end of the revolution part (82), the displacement portion (821), the at least one sliding ball or the displacement clip (411) replaces the displacement part (41) to directly contact the positioning slot (71);
(3) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved over the rotation lug (412), the revolution part (82) is rotatable relative to the rotation lug (412), a displacement portion (821) is provided at another end of the revolution part (82), the displacement portion (821), the at least one sliding ball or the displacement clip (411) replaces the displacement part (41) to contact directly the positioning slot (71); the displacement part (41) is capable of leftward and rightward deformation and bending, and is bendable for a certain extent, consequently, when the displacement part (41) moves in the positioning slot (71), without moving the adjusting part (4), the displacement part (41) can move leftward or rightward;
(4) a displacement clip (411), a sliding ball slot or a rotation lug (412) is provided on the displacement part (41), at least one sliding ball is provided in between the sliding ball slot and the positioning slot (71); a revolution part (82) is provided on the rotation lug (412), an end of the revolution part (82) is sleeved onto the rotation lug (412), the revolution part (82) is rotatable relative to the rotation lug (412), a displacement portion (821) is provided at another end of the revolution part (82), the displacement portion (821), the at least one sliding ball or the displacement clip (411) replaces the displacement part (41) to contact directly the positioning slot (71); when to move leftward and rightward, the adjusting part (4) will move leftward and/or rightward;
(5) the displacement part (41) is independent from the adjusting part (4), a displacement clip (411), a sliding ball slot, a movable slot or a rotation lug (412) is provided on the displacement part (41), at least one sliding ball is provided in between the movable slot or the sliding ball slot and the positioning slot (71); a revolution part (82) is provided on the rotation lug (412), an end of the revolution part (82) is sleeved onto the rotation lug (412), the revolution part (82) is rotatable relative to the rotation lug (412), a displacement portion (821) is provided on another end of the revolution part (82), the displacement portion (821), the at least one sliding ball or the displacement clip (411) replaces the displacement part (411) to contact directly the positioning slot (71); the displacement part (41) and the adjusting part (4) engage by magnetic adsorption, clearance fit, abrasives and/or threaded connection;
(6) a rotation lug (412) is provided on the displacement part (41), a revolution part (82) is provided on the rotation lug (412), an end of the revolution part (82) is installed on the rotation lug (412), the revolution part (82) is rotatable relative to the rotation lug (412), a displacement portion (821) is provided at another end of the revolution part (82) and the displacement portion (821) replaces the displacement part (41) to contact directly the positioning slot (71);
(7) a rotation through-hole (41F) is provided on the displacement part (41), a revolution part (82) is provided in the rotation through-hole (41F), the revolution part (82) is rotatable relative to the rotation through-hole (41F), a displacement portion (821) is provided at another end of the revolution part (82), and the displacement portion (821) replaces the displacement part (41) to contact directly the positioning part (71); and
(8) with assistance of third-party accessories, the displacement part (41) can move leftward or rightward in the positioning slot (71).

20. The mechanical pencil according to claim 18, wherein, in the solution (7), a rotation stabilizing lug (45) is provided on the adjusting part (4); a rotation abutment boss (413) for connecting with and adjusting the revolution part (82) is provided on the displacement part (41) and/or an abutment lug for connecting with and adjusting the revolution part (82) is provided on the positioning part (7); a rotation assistance boss (822) and/or a rotation installation notch (823) is provided on the revolution part (82); a deformation groove (713K) is provided on the lead driving lug (713), the positioning part (7), the displacement part (41), the sleeve (1), the revolution part (82) and/or the rotation installation notch (413).

21. The mechanical pencil according to claim 19, wherein, in the solution (7), a rotation stabilizing lug (45) is provided on the adjusting part (4); a rotation abutment boss (413) for connecting with and adjusting the revolution part (82) is provided on the displacement part (41) and/or an abutment lug for connecting with and adjusting the revolution part (82) is provided on the positioning part (7); a rotation assistance boss (822) and/or a rotation installation notch (823) is provided on the revolution part (82); a deformation groove (713K) is provided on the lead driving lug (713), the positioning part (7), the displacement part (41), the sleeve (1), the revolution part (82) and/or the rotation installation notch (413).

22. The mechanical pencil according to claim 18, wherein at least one rotation stopper (4121) is provided on the displacement part (41), the rotation lug (412), in the rotation through-hole (41F) and/or on the revolution part (82).

23. The mechanical pencil according to claim 19, wherein at least one rotation stopper (4121) is provided on the displacement part (41), the rotation lug (412), in the rotation through-hole (41F) and/or on the revolution part (82).

24. The mechanical pencil according to claim 20, wherein at least one rotation stopper (4121) is provided on the displacement part (41), the rotation lug (412), in the rotation through-hole (41F) and/or on the revolution part (82).

25. The mechanical pencil according to claim 8, wherein at least one rotation stopper (4121) is provided on the displacement part (41), the rotation lug (412), in the rotation through-hole (41F) and/or on the revolution part (82).

26. The mechanical pencil according to claim 21, wherein at least one rotation stopper (4121) is provided on the displacement part (41), the rotation lug (412), in the rotation through-hole (41F) and/or on the revolution part (82).
